(19) United States
(12) Patent Application Publication
(10) Pub. No.: US 2015/0081701 A1
(43) Pub. Date: Mar. 19, 2015

(54) SYSTEMS AND METHODS FOR DATA FLOW EXPLORATION

(71) Applicant: Metanautix, Inc., Palo Alto, CA (US)

(72) Inventors: Apostolos Lerios, Austin, TX (US); Theodore Vassilakis, Los Altos, CA (US); Laurent An Minh Nguyen, Los Altos, CA (US); James Mark Adler, Mountain View, CA (US); Lawrence David Cutler, San Francisco, CA (US); Daron Alan Scarborough, Monte Rio, CA (US)

(21) Appl. No.: 14/486,995

(22) Filed: Sep. 15, 2014

Related U.S. Application Data
(60) Provisional application No. 61/878,562, filed on Sep. 16, 2013.

(51) Int. Cl. G06F 17/30; H04L 12/26

(52) U.S. Cl. CPC G06F 17/30876; H04L 43/045
USPC 707/736

(57) ABSTRACT

Systems, methods, and non-transitory computer readable media configured to capture a first data flow between a data source and a data client. One or more elements relating to the first data flow are determined. At least one element of the first data flow is tagged with a first tag. A visual representation of the first data flow based on the elements relating to the data is generated. The visual representation of the first data flow is adjusted according to the first tag in response to selection of the first tag.

### CROSS-REFERENCE TO RELATED APPLICATIONS

The present application claims priority from U.S. Provisional Patent Application Ser. No. 61/878,562, filed Sep. 16, 2013, entitled “SYSTEMS AND METHODS FOR DATA FLOW EXPLORATION,” which is incorporated herein by reference.

### FIELD OF THE INVENTION

Inventions disclosed herein relate to data analysis and, more particularly, provide analyzing data flows between data sources and data clients.

### BACKGROUND

It is known that modern businesses generate and exchange digital data as a result of their operation. Digital data, such as e-mails, electronic documents, accessing the Internet, and accessing databases, are commonplace and are often used to facilitate various operations within a business. As such digital data is exchanged between computing devices (e.g., over a computer network), the exchanges form a flow of data (i.e., data flow), which when analyzed can provide useful insights into business operations and assist businesses and enterprises in making business decisions (e.g., data security or data policy decisions).

Unfortunately, information regarding data flows is often limited to log files (e.g., server log files) that contain information regarding various data transactions (e.g., data exchanges) but provides such information as raw data (e.g., unformatted or lacking in readability) containing little or no analysis or intelligence regarding the transactions. In the context of large business enterprises, this lack of data analysis or intelligence is further exasperated by the number of data flows present in such organizations and the large amounts of log data generated therefrom. It would be beneficial to have tools that can analyze information regarding data flows (e.g., log files describing data transactions) and provide intelligent analysis (for such data flows) that is easy to read/understand.

### SUMMARY

Various embodiments of the present disclosure can include systems, methods, and non-transitory computer readable media configured to capture a first data flow between a data source and a data client. One or more elements relating to the first data flow are determined. At least one element of the first data flow is tagged with a first tag. A visual representation of the first data flow based on the elements relating to the data is generated. The visual representation of the first data flow is adjusted according to the first tag in response to selection of the first tag.

In an embodiment, the first tag is selected by a user.

In an embodiment, another element of the first data flow is tagged with a second tag. The adjusting the visual representation includes adjusting the visual representation of the first data flow according to the first tag and the second tag in response to selection of the first tag and selection of the second tag.

In an embodiment, at least one element of the first data flow is annotated with an annotation, the visual representation including the annotation.

In an embodiment, the first data flow is analyzed. A process for a second data flow is optimized based on the analyzing of the first data flow, the second data flow occurring subsequent to the first data flow.

In an embodiment, the second data flow is captured. The second data flow is analyzed using at least the optimized process.

In an embodiment, a second data flow is captured. A first semantic identity for the first data flow is determined. A second semantic identity for the second data flow is determined. It is determined whether the first semantic identity and the second semantic identity are similar or identical. The first and second data flows may be considered to have similar or identical semantic identities (and thus aliases of each other) when, for example, the first and second data flows involve duplicate emails or a failed re-transmission of a lost network packet (which leads to a second, again lost, packet).

In an embodiment, the first data flow relates to a first database query to a data source, the second data flow relates to a second database query to the data source, the first semantic identity is a first query alias, and the second semantic identity is a second query alias.

In an embodiment, the first data flow is analyzed based on the determining whether the first semantic identity and the second semantic identity are similar or identical.

In an embodiment, the second data flow is analyzed based on the determining whether the first semantic identity and the second semantic identity are similar or identical.

In an embodiment, at least one of the capturing the first data flow, the tagging the at least one element of the first data flow, and the selection of the first tag is performed based on a user-defined script.

In an embodiment, the user-defined script is performed (e.g., executed).

In an embodiment, the user-defined script is received from a user.

In an embodiment, the user-defined script is performed (e.g., executed) based on satisfaction of a condition.

In an embodiment, the condition includes an occurrence of at least one of an event, a date, and a time.

In an embodiment, the first tag is organized in a tag hierarchy.

In an embodiment, the tag hierarchy comprises an acyclic graph of tags.

In an embodiment, a search is performed based on the first tag.

In an embodiment, two or more users are provided collaborative access to the visual representation and the first tag.

Many other features and embodiments of the invention will be apparent from the accompanying drawings and from the following detailed description.

### BRIEF DESCRIPTION OF THE DRAWINGS

FIG. 1 illustrates an example environment for a data flow exploration system, according to an embodiment of the present disclosure.

FIG. 2 illustrates an example data flow exploration system, according to an embodiment of the present disclosure.

FIG. 3 illustrates an example data flow exploration client, according to an embodiment of the present disclosure.

FIG. 4 illustrates an example data flow capture module, according to an embodiment of the present disclosure.

FIG. 5 illustrates an example data flow analysis module, according to an embodiment of the present disclosure.

FIG. 6 illustrates an example process for analyzing data flows, according to an embodiment of the present disclosure.

FIG. 7 illustrates a screenshot of a Sankey diagram generated to visualize multiple database data flows between database tables functioning as data sources and database users serving as data clients, according to an embodiment of the present disclosure.

FIG. 8 illustrates a screenshot of a Sankey diagram once a particular tag associated with a tag hierarchy is selected for the database tables, according to an embodiment of the present disclosure.

FIG. 9 illustrates a screenshot of a table including detailed measurements in regard to a normalized query relating to a database data flow, according to an embodiment of the present disclosure.

FIG. 10 illustrates a screenshot of a Sankey diagram generated to visualize multiple database data flows, according to an embodiment of the present disclosure.

FIG. 11 illustrates a screenshot of a Sankey diagram generated to visualize multiple database data flows, according to an embodiment of the present disclosure.

FIG. 12 illustrates an example of a computer system that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

In various embodiments, systems and methods are provided to analyze one or more data flows between data sources and data clients. Such systems and methods can be beneficial for analyzing and providing understanding of data flows, between data sources and data clients, within an organization or across different organizations.

In some instances, analysis of data flows as described herein may facilitate various operations with respect to data supply chains. For example, analysis of data flows may maintain security or proper performance of data supply chains by way of monitoring or auditing the data supply chains using data flow analysis. An example of a data supply chain may include one between two collaborating companies that are sharing proprietary data with each other in the context of their collaboration. Another data supply chain may involve multiple parties collaborating on a single project, such as a general contractor and multiple sub-contractors. Additional examples of supply chains may include (1) advertising or user data submitted by advertisers to advertising agents or e-commerce systems, (2) pricing and inventory data submitted by companies in the digital view of their physical supply chains, or (3) billing, revenue and other financial data submitted by companies to their billing or other processing vendors and returned back in processed form.

Yet another example of a data supply chain may involve escrowing data, where distrusting parties are willing to have their data correlated to produce overall statistics, but are unwilling to have any single party among the participants perform the analysis of their data. The data escrow may receive the raw data, perform the analysis, and share the aggregate results with all companies. For example, companies may share their employee compensation information with a firm that calculates average compensation, and shares that average with the companies participating in the calculation of the average; each company may then gauge its own compensation against that average. When escrowing data, the data supply chains may comprise those between the data escrow and the escrow parties. Data flow analysis may ensure the security of the data escrow and guarantee to each party that their data was not made available to other parties, with the analysis being conducted in an ongoing or static, one-time basis.

A “data flow,” as used herein, may include a transfer of data between a data source and a data client. Examples of data flows can include an e-mail being delivered from an e-mail server (e.g., Microsoft® Exchange) to an e-mail client (e.g., Microsoft® Outlook®), an e-mail being sent from an e-mail client to an e-mail server, a database query result (e.g., table) being provided by a database server (e.g., MySQL®) to a database client (e.g., MySQL® Workbench, or PHP process) in response to a structured query language (SQL) query, and a SQL query being delivered for execution from a database client to a database server. A data flow may also be more general, such as a money flow from an investor, into an entity receiving the investment, through an investing event. Each of these generalized components of the data flow may be represented in the system in a standard computational form, for example through a database record, a file, or other forms.

A “data source,” as used herein, may include any entity initiating or providing data through a data flow. Examples of data sources can include the sender of an e-mail (e.g., where the e-mail is the data), a file stored on a file system (e.g., where the data being sent is the content of the file), a database (e.g., where data is some or all of the tables of the database), or a table in a database (e.g., wherein the data being sent is the contents of the table, in whole or in part). In some embodiments, a single data flow may have multiple collaborating data sources, such as two joined database tables. Herein, a data client source may also be referred to as a “data producer.” In a more general investment data flow, the entity may be the actual real-world entity performing the investment, as represented in the system.

A “data client,” as used herein, may include any entity serving as the endpoint of a data flow and receiving data transferred through the data flow. Examples of data clients can include a recipient of an email, or a person viewing contents of a database table. In some embodiments, a single data flow may have multiple data clients, such as an email sent to multiple recipients. Herein, a data client may also be referred to as a “data consumer” or “data sink.”

As used herein, an entity serving as a data source or a data client may be understood to be implemented by, or utilizing, one or more computing modules as described herein in further detail. In addition, it will be understood that an entity that serves as a data client in one context (e.g., with respect to a first data flow) can also serve as a data source in another context (e.g., with respect to a second data flow). For example, where a first data flow comprises a database query sent from a database client to a database server, the database client may be regarded as the data source with respect to the first data flow, and the database server may be regarded as the data client with respect to the first data flow. Where a second data flow comprises a database query result sent from the same database server to the same database client (e.g., in response to the database query of the first data flow), the database server may be regarded as the data source with respect to the second data flow, and the database client may be regarded as the data client with respect to the second data flow.

A “data flow transaction,” also referred to herein as a “transaction,” may be a unique instance of a data flow. A data flow transaction may, for example, comprise a single email that flowed from one or more data sources to one or more data clients. For the purposes of analysis, a data flow transaction may be deemed to have taken place regardless of the ultimate success or failure of a data flow transaction. Accordingly, in some instances, a given data flow transaction may not necessarily comprise expected data but, rather, an error or an empty data result (e.g., empty query result). For example, a data flow transaction may comprise an e-mail sent to a nonexistent e-mail account, or an error resulting from the e-mail being sent to a nonexistent e-mail account. When analyzed, a data flow transaction may be associated with appropriate data flow transaction metrics (also referred to herein as “metrics”), such as the number of bytes in the e-mail or a transmission error code.

A “data topic,” as used herein, may be a semantic meaning associated with a data flow. As used herein, two or more data flow transactions that are semantically related may be said to be related to the same data topic. Data flow transactions may be semantically related based on context. For example, a SQL query such as “SELECT t1.c1, t1.c2 FROM t1,” which intends to retrieve data from all rows in table t1 for columns c1 and c2, can be related to a data topic based on: the specific stream of table data obtained from database table t1 at a particular point in time; any stream of table data obtained from the database table t1 (whose contents may change over time) no matter when that query is executed; or any stream of table data obtained from the database table t1. A data topic, comprising multiple data flow transactions, may facilitate computing statistical quantities (also referred to herein as “statistics”) with respect to the data topic, such as averages and standard deviations.

A “tag,” as used herein, may be a text-based label or keyword associated with elements associated with a data flow or the data flow as a whole. Elements of a data flow that may be tagged may include, for example, one or more entities (e.g., data sources, data topics, or data clients) associated with the data flow, or one or more annotations associated with the data flow. Once one or more elements are associated with a tag, those elements may be grouped, located, sorted, filtered, or otherwise acted upon based on/according to the tag. A given element may be associated with one or more tags. As used herein, “tagging” an element with a tag will be understood to associate that element with the tag.

Depending on the embodiment, one or more tags may be automatically associated with elements, or may be associated with elements by a user action. For some embodiments, the automatic association of tags with a data flow or its elements may be based on their respective attributes. For example, two or more tables of a database functioning as data sources for a data flow may be automatically tagged with the name of the table schema or the name of the database containing those tables. In another example, where a data flow involves an e-mail sender as the data source and an e-mail recipient as the data client, the e-mail sender or the e-mail recipient of the data flow may be automatically and respectively tagged with the name of the organization or department of which they are a member. In a further example, where a data flow is associated with a particular data topic, such a data flow may be automatically tagged with a tag associated with that data topic.

For some embodiments, automatic tagging of elements may be facilitated by way of a script (e.g., pre-installed or user-defined) executed by a user and configured such that data flows or their elements are automatically tagged based on a set of criteria defined by the script. In some embodiments, the criteria may be evaluated based on or according to the results of the data flow analysis.

The set of tags from which a user or automatic process may select and associate with an element may include user-defined tags and tags automatically associated with other elements. Additionally, tags may be organized according to a structural hierarchy such that the association of a first tag with an element may result in that element being associated with a second tag related to the first tag through the structural hierarchy. For example, a tag hierarchy may include one where tags are organized according to a directed acyclic graph (e.g., tree-like structure, but potentially more general). More regarding tags is discussed herein in detail.

In various embodiments, analyzing a data flow may comprise capturing the data flow, pre-processing data captured in the data flow, storing information extracted during pre-processing of the data, analyzing the stored information, exporting stored information and/or analysis results, and optimizing data flow processes (e.g., future data flow analysis). Depending on the embodiment, a data flow may be capture from live data flows or may be captured from data previously logged (or represented in some form) with respect to the data flow.

In some embodiments, systems and methods may be configured to analyze a data flow for an e-mail system in order to understand how e-mail flows within an organization. The systems and methods may provide information regarding: how many e-mails (as transactions) did a first user (as a data source) send today; how many e-mails (as transactions) did the first user (as a data client) receive today; which thread of e-mail conversation (data flow transactions related to a data topic) has used the most amount of traffic (e.g., total number of bytes across all e-mails under a data topic); or which e-mails (as data flow transactions) are addressed to non-existent recipients (as data clients).

In various embodiments, systems and methods may be configured to analyze data flows involving database queries and database query results (referred to herein as “database data flows”). In such data flows, the data source may be database tables, the transactions may be individual database queries (e.g., SQL queries) or database query results, the data topics may be groups of database queries that are semantically related, and the data clients may be users at computing devices who submit the database queries to the database server for execution.

Based on the understanding that a database query has a single canonical semantic form, in terms of cardinality, each transaction may be associated with a single data topic, a single user, and with one or more tables. Each transaction may be executed by a single user and retrieve information from the one or more tables. In some embodiments, detailed database queries may be utilized during analysis of database data flow transactions, while canonical database queries may be utilized when database transactions are analyzed according to a data topic. Herein, a canonical database query may also be referred to as a “normalized database query” or simply “normalized query.”

In various embodiments, database tables may be regarded as data clients that receive data from other database tables regarded as data sources. The concept of data flowing from a first set of database tables to a second set of database tables may be similar to lineage or provenance, where data flows from an original table to an end-user through a sequence of intermediate tables. Analyzing such data flows may be useful in instances where, for example, a system administrator wishes to know if some database user has received (through whatever intermediate steps) data stored in some original table. This is similar to the notion of e-mail forwarding, and a system administrator wishing to know whether a first e-mail user has ever seen any e-mail authored by a second e-mail user, whether the second e-mail user sent it to the first e-mail user, or whether some other e-mail user forwarded an email authored by the second to the first e-mail user.

For some embodiments, a column or table may be treated as a data source for a specific data flow even if the data from the column or table is not delivered by way of a database query. In particular embodiments, systems and methods may regard as a data flow a table or a column that supplies intact data or aggregate data. For instance, an example database query “SELECT SUM(t1.c1) FROM t1” delivers the sum of values in column c1 for table t1. In another instance, for a SQL statement that performs a join between multiple tables, the selection of the result rows may be influenced by all the tables in the statement's FROM clause, and the columns delivered may include none of the columns in one (or more) of these tables.

In some embodiments, the systems and methods described herein may be configured to operate with respect to data flows relating to a query engine capable of treating separate and non-homogenous data sources (e.g., a database, which may be maintained at one geographic location, and a flat file, which may be maintained at another geographic location) as a unified data source and operate across a unified data source.

For example, the query engine may be adapted to execute queries involving a PostgreSQL database, which may be hosted at one computing device, and a comma-separated-value (CSV) file, which may be stored on another computing device, where the computing devices may be separated by large geographic and network distances. Rather than merely route a query involving one or more data sources to those data sources, the query engine may be configured to retrieve distinct data from the data sources as part of a single “planetary” query, join the distinct data, filter the joined data, and generate aggregates from the joined data. In some embodiments, the foregoing query engine may be utilized with systems and methods described herein such that the query engine enables or otherwise facilitates query based access (e.g., exploration) by external or independent systems and methods (e.g., third party access) to data sets stored or generated by the described systems and methods. The systems and methods described herein may also utilize the foregoing query engine for the purpose of querying stored information that was extracted during pre-processing of the data flows, or other internal analysis purposes.

As detailed herein, the systems and methods of various embodiments may be utilized with respect to data flows involving different types of data, including data relating to database queries and electronic communications. In alternative embodiments, the systems and methods described herein may be adapted to analyze or otherwise explore flows not relating to data transfers, such as currency flows (e.g., based on financial transactions), how products flow through a stream of commerce (e.g., flow of tangible resources, such as gasoline, flowing from a gasoline producer to a gasoline consumer), or actual flow of physical matter (e.g., water flow or air flow).

The figures described herein depict various embodiments of the present invention for purposes of illustration only. Alternative embodiments of the structures and methods illustrated in the figures may be employed without departing from the principles of the invention described herein.

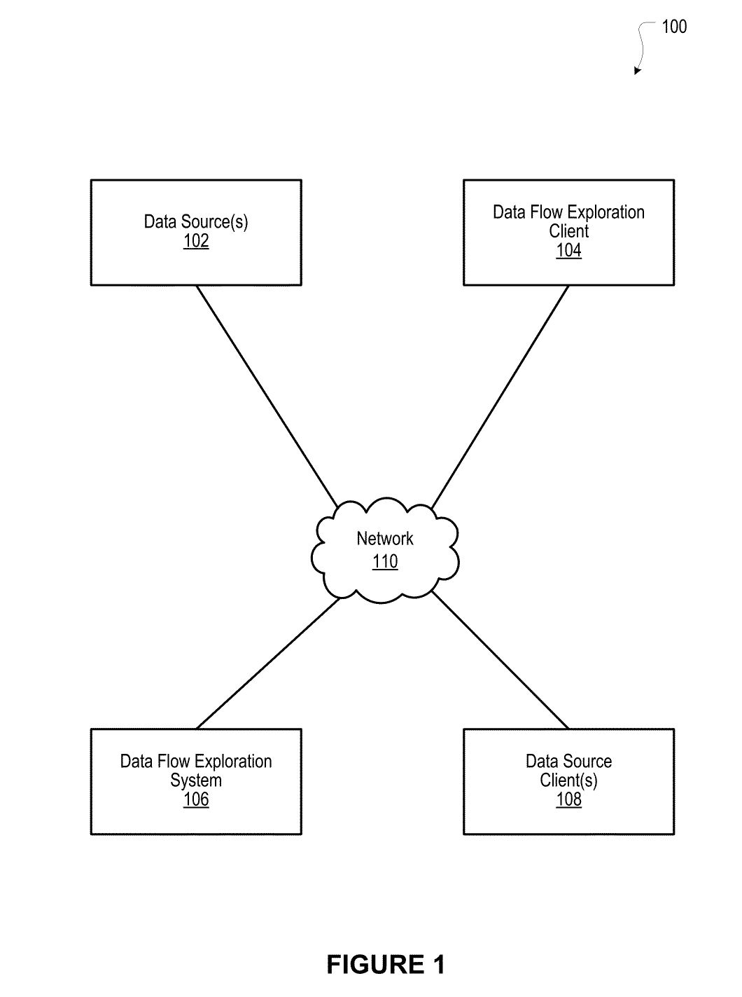

FIG. 1 illustrates an example environment 100 for a data flow exploration system in accordance with an embodiment of the invention. As shown, the example environment 100 comprises one or more data sources 102, a data flow exploration client 104, and a data flow exploration system 106, and one or more data clients 108 communicatively coupled through a network 110 that facilitates data communication therebetween.

As discussed herein, the data sources 102 may be entities that initiate or provide data through a data flow, while the data clients 108 may be entities that serve as endpoints for data flows and receive the data transferred through the data flows. As also discussed herein, the data sources 102 and the data clients 108 may be implemented by, or utilize, one or more computing modules as described herein. Examples of the data sources 102 may include, without limitation, the sender of an e-mail (e.g., where the e-mail is the data), a file stored on a file system (e.g., where the data being sent is the content of the file), a database (e.g., where data is some or all of the tables of the database), or a table in a database (e.g., wherein the data being sent is the contents of the table, in whole or in part). Examples of the data clients 108 may include, without limitation, a recipient of an email, or a person viewing contents of a database table.

The data flow exploration client 104 may be configured to access features or services provided by the data flow exploration system 106 over the network 110. The data flow exploration client 104 may comprise a computing device, such as laptop, desktop, mobile device, or the like, capable of providing a user at the data flow exploration client 104 with a software interface (e.g., graphical or non-graphical user interface) facilitating user access to the data flow exploration system 106. Through a software interface, a user at the data flow exploration client 104 may be able to interact with the data flow exploration system 106 and utilize its provided features or services. In one example, a user at the data flow exploration client 104 may request the data flow exploration system 106 to perform one or more operations with respect to one or more data flows being monitored by the data flow exploration system 106, such operations including analyzing the data flows or providing analysis results for the data flows.

The data flow exploration system 106 may be configured to perform various operations with respect to one or more data flows between the data sources 102 and the data clients 108. In some embodiments, the data flow exploration system 106 may capture a data flow, pre-process data in the captured data flow, store information extracted during the pre-processing, analyze the captured data flow based at least in part on the information extracted during the pre-processing, export the information extracted during the pre-processing and/or analysis results, or optimize one or more data flow processes based on the analysis of the captured data flow. The data flow exploration client 104 may control or otherwise access the results of the operations performed by the data flow exploration system 106. For example, the data flow exploration system 106 may provide the results of analyzing data flows monitored and captured by the data flow exploration system 106. Such analysis results may be provided by way of a visual representation of the captured data flows (e.g., a Sankey diagram) that incorporates the analysis results. In some embodiments, an interactive version of the visual representation may enable a user at the data flow exploration client 104 to interactively navigate the visual representation. The interactive navigation may include GUI-based interactions to enable or otherwise facilitate grouping or filtering of the data flows that are presented in the interactive visual representation (also referred to herein as “interactive visualization”). More regarding data flow exploration systems is discussed later herein.

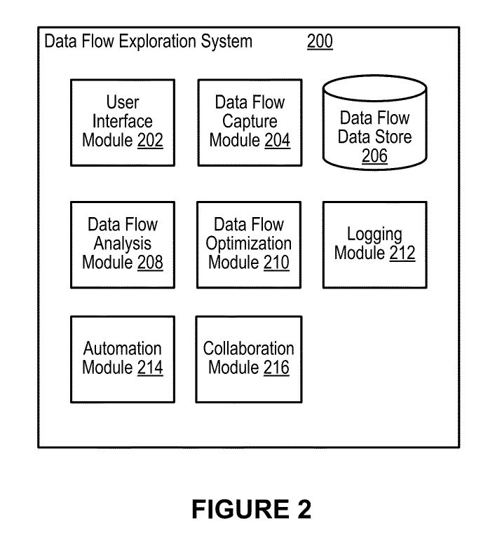

FIG. 2 illustrates an example data flow exploration system 200 in accordance with an embodiment of the invention. For some embodiments, the data flow exploration system 200 may be similar to the data flow exploration system 106 described above with respect to FIG. 1. As shown, the data flow exploration system 200 comprises a user interface module 202, a data flow capture module 204, a data flow data store 206, a data flow analysis module 208, a data flow optimization module 210, a logging module 212, an automation module 214, and a collaboration module 216. In accordance with some embodiments, the data flow exploration system 200 may be configured to perform various data flow related operations described herein. Such operations may include, without limitation, capturing a data flow, pre-processing data captured in a data flow, storing information extracted during pre-processing of data from a data flow, analyzing the stored information, exporting stored information and/or analysis results, and optimizing data flow processes.

The user interface module 202 may be configured to provide or otherwise facilitates a user interface utilized by a user at a data flow exploration client (e.g., 104) to access or interact with the data flow exploration system 200. In some embodiments, the user interface module 202 may be configured to generate and provide a web-based user interface, which may be compatible with a web-enabled application at the data flow exploration client, such as a web browser application. Through the user interface, users may control the operations of the data flow exploration system 200, and may further access configurations relating to the data flow exploration system 200. In various embodiments, the user interface module 202 may provide application program interfaces (APIs) that enable external applications or systems to programmatically access (e.g., services or features) provided by the data flow exploration system 200.

The data flow capture module 204 may be configured to capture a data flow between a data source (e.g., 102) and a data client (e.g., 108). Capturing the data flow facilitates monitoring and awareness of data flow transactions. In accordance with some embodiments, capturing the data flow may comprise obtaining some or all of the data included in the data flow, and may comprise obtaining various attributes regarding the data included in the data flow (e.g., metadata in the data or generated based on the data). For instance, where the data flow to be captured relates to e-mails processed by a given e-mail server (e.g., Microsoft® Exchange®), capturing the data flow may involve the given e-mail server forwarding a copy of every e-mail processed by the given e-mail server (where the copy includes full e-mail headers) to a special account on the given e-mail server which is monitored for data flow analysis purposes. In some embodiments, the data flow capture module 204 may capture a data flow by way of pulling data from a data source, receiving data (e.g., a notification) pushed from a data source, or functioning as a proxy for a data flow between a data source and a data client. Other embodiments may utilize additional or alternative methods for retrieving or capturing data from data flows between data sources and data clients.

The data flow data store 206 may be configured to receive, store, and facilitate subsequent retrieval of various data generated or collected by the data flow exploration system 200 during its operation. Data that may be stored in the data flow data store 206 may include some or all of the data flow captured by the data flow capture module 204, analysis or pre-analysis data generated by the data flow analysis module 208, data (e.g., scripts) generated by the data flow optimization module 210, log data collected or generated by the logging module 212, and data (e.g., triggers) generated by the automation module 214. In some embodiments, some or the entire data flow data store 206 may be implemented, in whole or in part, using a persistent storage system, such as a database or a file system.

The data flow analysis module 208 may be configured to perform operations relating to the analysis of data flows. Such operations may include pre-processing of data in a captured data flow, storing information extracted during pre-processing of data in a captured data flow (e.g., to the data flow data store 206), analyzing a captured data flow based at least in part on information extracted during pre-processing of data in a captured data flow, or exporting information extracted during pre-processing of data in a captured data flow and/or analysis results. More regarding data flow analysis modules is discussed later herein.

The data flow optimization module 210 may be configured to optimize one or more data flow processes for future data flows based on analysis of a captured data flow, which may be performed by the data flow analysis module 208. For some embodiments, the future data flow for which processing is optimized may be a data flow captured (e.g., by the data flow capture module 204) subsequent to the capture and/or analysis of the data flow that is causing the optimization. Additionally, the future data flow affected by the optimization may be one that is or is not related to the data flow that is causing the optimization. The data flow processing being optimized may comprise any process involving data flows, including the data flow analysis process being performed by the data flow analysis module 208.

The optimization of data flow processes for future data flows may be based on analysis of the information relating to the data flow that caused the optimization, which may be provided by the data flow analysis module 208. By optimizing based on analysis of the information relating to the data flow, the data flow optimization module 210 can translate one or more results of the analysis performed by the data flow analysis module 208 into actions that affect processing (e.g., analysis) of future data flows.

One example of optimizing for future data flows may involve a first data flow analysis including a first e-mail, sent by a first user (e.g., Bob) to users in a particular group (e.g., “Compliance”), requesting a particular document (e.g., a document relating to a “10-K filing”). The example may further involve a second data flow that includes a second e-mail, sent by a second user in the particular group (e.g., Sue in the “Compliance” group) to only the first user (e.g., Bob), replying to the initial e-mail, possibly with a file attachment entitled “10-K,” thereby leaving all other members of the particular group unaware of the second e-mail. Based on analyzing the first and second data flows (e.g., analyzed based on information extracted from the first and second data flows), the data flow optimization module 210 may optimize processing performed by the data flow analysis module 208 to automatically send a copy of the second e-mail to the remaining users of the particular group, or to automatically send a third e-mail notifying the remaining users of the particular group that the particular user (e.g., Sue) replied to the given user's (e.g., Bob's) first e-mail.

Another example of optimizing for future data flows may involve a data flow including a particular e-mail associated with a particular data tag (e.g., “Confidential”) and forwarded to an e-mail address that is outside the sender's organization or not part of an e-mail domain used in past e-mails associated with the particular data topic. In such an example, the forwarded e-mail may be a potential security leak or a legitimate data transaction. Based on analyzing the data flow (e.g., analyzed based on information extracted from the data flow), the data flow optimization module 210 may cause the execution of a user-defined script (e.g., “Leak Suspected” script), which may be configured to cause a user (e.g., data security manager) to be alerted regarding the forwarded e-mail. Depending on the embodiments, the user may be alerted through a visualization representing the data flow (e.g., red exclamation mark shown with respect to the data flow), through a message to the user (e.g., e-mail to the user), or some other manner.

An additional example of optimizing for future data flows may involve a data flow involving a computing task (e.g., background task) that has potentially been forgotten and/or is wasting computing resources, or that is potentially known to be an active task but consumes disproportionate amounts of computing resources. In such an example, the data flow analysis module 208 may collect resource metrics during the pre-processing of data in the captured data flow, such metrics including network socket status, processor time, and memory used by data flows. For example, consider where the task of the captured data flow comprises a database query that a first user (e.g., accountant Bob) normally uses for periodic reports (e.g., daily Quickbooks® reports), the reporting application (e.g., Quickbooks®) runs on the first user's laptop, and all database queries execute on a back-office server. Unbeknownst to the first user (e.g., Bob), when their laptop temporarily lost its Internet connection, the reporting application (e.g., Quickbooks®) ended up leaving behind an orphaned instance of the database query, where an orphaned instance is one whose execution is wasteful as its output will never be used by anyone. By way of analyzing the captured data flow based on the metrics collected, the data flow optimization module 210 may optimize for future data flows relating to the orphaned instance of the database query (e.g., future execution of the database query), particularly by notifying a human operator (e.g., the database administrator) of future occasions where generation of the same report as in past occasions requires issuing more queries than it did in said past occasions. Such an occurrence may suggest that one or more queries got orphaned during report generation and, hence, had to be re-issued to complete the report generation.

The logging module 212 may be configured to record a log of operations performed by the data flow exploration system 200, which may include those operations associated with user interaction with the data flow exploration system 200. User interactions that may be logged by the logging module 212 may include those facilitated via a user interface provided by the data flow exploration system 200 (e.g., through the user interface module 202), scripts, or APIs utilized by systems external to the data flow exploration system 200 (e.g., a third-party subsystem such as the notes subsystem). In some embodiments, the log data generated or otherwise recorded by the logging module 212 may be analyzed using the data flow analysis module 208. For example, the log data may be analyzed such that the data sources are portions of the data flow data store 206, the data topics are user interface pages or scripts, and the users at the data flow exploration clients (e.g., 104) are the data clients. In this way, the data flow exploration system 200 may be utilized in observing or tracking data flow exploration by users or scripts within the data flow exploration system 200. In some instances, this can allow an administrator to the data flow exploration system 200 to reduce the risk of, or eliminate, use of the data flow exploration system 200 by secret lurkers wishing to gain operational insight into a customer's organization with malevolent intent (e.g., lurker who looks for database queries that set credit card number and collects them).

The logging module 212 may permit logging to be suspended or re-routed. For instance, where an organization wishes to perform an internal investigation of a particular user (e.g., top executive) and the organization wants to prevent the particular user from realizing that their data flows are being scrutinized by an investigator (e.g., who may be her subordinate and, as such, the particular user may have power over them). In such a case, it would be preferable to keep such an investigation private otherwise the particular user may distract, demote or dismiss the investigator. Accordingly, the investigator's exploration of the particular user's data flow exploration activities should not be logged and the fact that the investigator's exploration is not being logged should not be visible to the particular user (e.g., lest it alert the particular user). Alternatively, the investigator's exploration of the particular user's data flow exploration activities could be logged but in such a manner that would make the logs inaccessible to the particular user. To avoid potential abuse of suspending or re-routing logging, the data flow exploration system 200 may implement a multi-key agreement protocol, such as one where a set of number of executives or administrators have to authorize the suspension or re-routing.

The automation module 214 may be configured to automatically initiate an action with respect to the data flow exploration system 200, based on prior instructions received from a user at a data flow exploration client (e.g., 104) and without need for an immediately preceding user action. For example, the automation module 214 may specify that a script for the data flow exploration system 200 be executed at regular intervals (e.g., daily), or in response to certain other events internal or external to the data flow exploration system 200. For instance, a script may be executed in response to the data flow exploration system 200 capturing new transactions that triggers an update for group-level statistics. As another example, a script may be executed in response to a third-party software directing the data flow exploration system 200 to perform an e-mail topic analysis that the third-party software then uses to adjust spam settings. An event that causes the script to execute may be referred to as a “trigger.” Once such a script executes, it may silently complete, or it may notify a user at a data flow exploration client of the completion.

In some embodiments, a trigger may be implemented using a time-based pattern (e.g., pattern like the cron timestamp specification). The time-based pattern may comprise a regular expression that is matched against a current timestamp and if it matches, the automation module 214 causes the execution of the script. For example, when a new minute begins, in the UTC time zone, the automation module 214 may generate a string of the format yyyy-MM-dd HH:mm (year, month, day, hour, minute), such as 2013-02-01 22:13 (22:13 UTC on Feb. 1, 2013). The automation module 214 may then check whether any known trigger matches such a string. The example trigger of “........01 22:15” (a regular expression meaning “any string starting with any 8 characters and ending with 01 22:15”) will not match “2013-02-01 22:13”, but the trigger “...........(10|22):13” (a regular expression meaning “any string starting with any 11 characters, followed by either 10 or 22, and ending with :13”) will match “2013-02-01 22:13” (it matches twice a day, every day, at 10:13 and 22:13 UTC). In another example, a trigger may specify a time zone other than UTC, to which the new minute is converted before generating the above string and making the subsequent comparison against the trigger's regular expression. A trigger of ‘never’ (a special string that is not interpreted as a regular expression pattern) may be associated with actions that need to be (usually temporarily) prevented from being initiated.

In various embodiments, a trigger may be implemented using an event of the data flow exploration system 200 (e.g., akin to a POSIX signal handler). The set of events may be well-defined and may be part of one or more APIs provided by the automation module 214. A user at a data flow exploration client (e.g., 104) may attach zero or more scripts to each event and, when such an event occurs, the automation module 214 may execute all the attached scripts, if any.

To avoid concurrent execution and resource overutilization caused by too many scripts triggering at once, scripts triggered by the automation module 214 may be queued up for execution by the data flow exploration system 200. The data flow exploration system 200, in turn, may only execute one trigger-initiated script at a time. For some embodiments, script execution may produce output and the output produced may be discarded or stored (e.g., into the data flow data store 206) within a note.

In some embodiments, the automation module 214 may present a listing of all script executions and may also provide links to the output of each script (if any). Where a script is configured to issue a notification (e.g., a short text message), the listing of script execution may include a special marker (e.g., an exclamation mark) next to such script executions that issued notifications.

For some embodiments, the automation module 214 may facilitate automation without the need for explicitly coding a script. For example, the automation module 214 may convert any table or visualization (e.g., Sankey diagram) provided by the data flow exploration system 200 into a script, which may then be attached to a time-based trigger chosen from among a set of options, such as daily, weekly, or monthly. The resulting script, when triggered, may regenerate or otherwise provide the associated table or visualization. In instances where that table or visualization includes any data, the script may issue a notification and capture that table or visualization inside a note. By such features, the automation module 214 may alert a user (e.g., administrator) whenever suspicious data flows occur.

The collaboration module 216 may be configured to facilitate collaboration between two or more users accessing a data flow exploration system (e.g., 200) from different data flow exploration clients. To assist in collaboration, the collaboration module 216 may maintain per-user customization for user interfaces that the data flow exploration system (e.g., 200) provides its users. Where some or all of the data flow exploration system (e.g., 200) is implemented through web-based interfaces, the links (e.g., URLs) to such web-based interfaces may be shared to further facilitate collaborative access to the features and services of a data flow exploration system (e.g., 200). For instance, a link to a visualization or tabulation of data flows accessible by a first user via the link, may be provided and utilized by a second user to access the same visualization or tabulation.

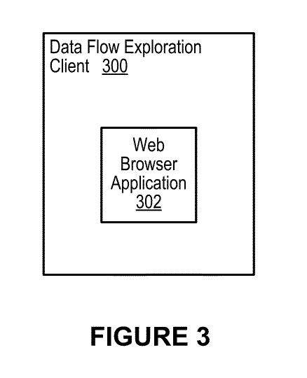

FIG. 3 illustrates an example data flow exploration client 300 in accordance with an embodiment of the invention. For some embodiments, the data flow exploration client 300 may be similar to the data flow exploration client 104 described above with respect to FIG. 1. Accordingly, the data flow exploration client 300 may be configured to access features or services provided by a data flow exploration system (e.g., 106). As described herein, the data flow exploration client 300 may comprise a computing device capable of providing a user at the data flow exploration client 300 with a graphical or non-graphical user interface that facilitates user access to the data flow exploration system. To that end, the data flow exploration client 300 comprises a web browser application 302 configured to access a web-based user interface, which may be provided by the data flow exploration system to facilitate access to its data flow features or services (e.g., visualization of data flow analysis). In other embodiments, the data flow exploration client 300 may comprise a software application configured to provide a user interface (e.g., GUI) that communicates with the data flow exploration system.

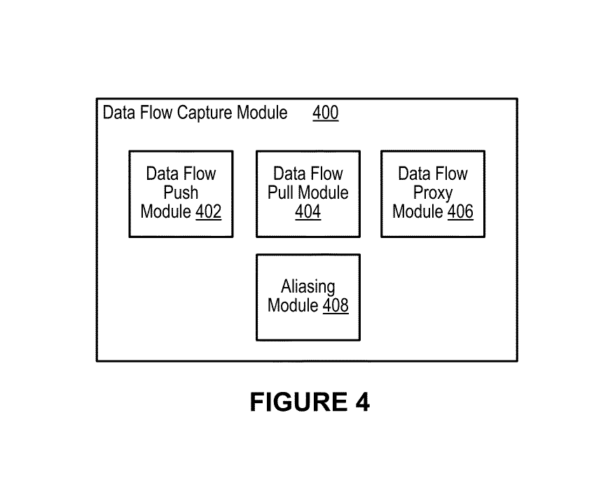

FIG. 4 illustrates an example data flow capture module 400 in accordance with an embodiment of the invention. For some embodiments, the data flow capture module 400 may be similar to the data flow capture module 204 described above with respect to FIG. 2. As shown, the data flow capture module 400 comprises a data flow push module 402, a data flow pull module 404, a data flow proxy module 406, and an aliasing module 408. In accordance with some embodiments, the data flow capture module 400 may be configured to capture a data flow between a data source (e.g., 102) and a data client (e.g., 108).

The data flow push module 402 may be configured to capture a data flow utilizing a push methodology. For example, the data flow push module 402 may implement a push method for capturing data flows by providing one or more APIs that external software systems (i.e., data sources) may utilize to notify the data flow push module 402 of a data flow transaction in a data flow. In response to receiving such a notification, the data flow push module 402 may retrieve some or all of the data in the data flow transaction from the external software system. In some embodiments, the data flow push module 402 may be configured to automatically receive some or all of the data in the data flow transaction, from the external software system, without the need for a notification/retrieval approach. In various embodiments, an external software system may push the data by adding rows to a data base accessible by the data flow push module 402 and the external software system (where each new row represents a data flow transaction).

The data flow pull module 404 may be configured to capture a data flow utilizing a pull methodology. For instance, the data flow pull module 404 may monitor stored data (e.g., log files or database tables), may monitor network activity, or may otherwise passively “listen” to the operation of a data source implemented by an external software system. Upon observing a data flow transaction in a data flow, the data flow pull module 404 can retrieve some or all of the data of the data flow transaction.

The data flow proxy module 406 may be configured to capture a data flow by intervening in the data flow and operating a proxy that carries information from a data source of the data flow to a data client of the data flow. The data flow proxy module 406 may implement or facilitate a passive proxy configured to make no changes to the data flow, or an active proxy configured to change (e.g., optimize) a data flow by way of re-routing, blocking, or otherwise altering a data flow. For example, where a data flow is one where a user is attempting to access confidential data, user-defined scripts (e.g., written by an administrative user of the data flow exploration system 200) may detect such access and instruct the data flow proxy module 406 to refuse the user proxy access to the data source. To implement the intervention of a data flow, the data source may include a module that functions as a counterpart to the data flow proxy module 406 and provides the data flow proxy module 406 (at the data flow capture module 400) with some or all of the data from the data flow being captured.

In certain embodiments, a proxy may be utilized that is an independent software system exposing API similar to a data source on one end, and API similar to a data client on the other end. To data clients, the proxy may appear to be no different than any other data source. To data sources, the proxy may appear to be no different than any other data client. In this way, the proxy may act as an intermediary between a true data source and client. For example, the client may deliver its request to the proxy as if it were a source; the proxy may then forward the client's request to the source as if it were a client itself; and responses may follow the reverse path. Such a mechanism does not require that the true data source include a module that functions as a counterpart to the proxy. In some embodiments, the method for listening for data flows may be independent of the deployment of the data flow system.

For some embodiments, capturing data flows may at times result in an incomplete or corrupted capture. For instance, consider a truncated log file that includes a query and the tables, but does not include the user. The data flow capture module 400 may assign an internal pseudo-user to that query, such as “Unknown User”. The data flow capture module 400 may have similar stand-ins for unknown queries or tables. In some embodiments, triggers may be configured to execute specialized logic for those cases.

The aliasing module 408 may be configured to automatically identify one or more aliases for an entity involved in one or more data flows captured by the data flow capture module 400. As used herein, an “alias” may be an alternate form by which the same entity may be observed in data flows. For instance, the same database table may be referred to as “t1” or as “T1” in a case-insensitive database system. In another example, a user Bob may be referred to via two different logins, “bobster” within queries against a Microsoft® SQL Server database and “bobby” within queries against an Oracle® database. The aliasing module 408 may monitor data flows after they are captured by the data flow capture module 400, and may associate aliases with entities observed in the data flows monitored (e.g., associate aliases “t1” and “T1” with the table “t1”, and aliases “bobster” and “bobby” with “Bob”). In some embodiments, information may be extracted may be on a record-by-record basis such that the capture and extraction of information from data flows are proximate but logically distinct.

Where the data flow involves database data flows (as opposed to e-mail data flows), the aliasing module 408 may utilize aliasing with respect to database queries to identify semantically identical queries. As described herein, semantically common meanings may be associated with data flows by utilizing data topics. By utilizing aliasing with respect to database queries, database performance analysis may be facilitated.

As an example of aliasing database queries, consider where a first SQL query comprises “SELECT t1.c1, t1.c2 FROM t1 WHERE 15<=t1.c1”, and a second SQL query comprises “SELECT t1.c2, t1.c1 FROM t1 WHERE t1.c1>=15”. The first and second SQL queries do not result in identical data flows as their columns (i.e., t1.c1 and t1.c2) are swapped. However, the first and second SQL queries may be regarded as semantically identical as they both: access the same table (i.e., t1), the same columns (i.e., t1.c1 and t1.c2), and the same rows (i.e., 15<=t1.c1 is equivalent to t1.c1>=15); and return the same data (just slightly reordered). The first and second SQL queries may need to be treated as semantically identical for database performance analysis purposes. As the first and second SQL queries may be regarded as semantically identical, they may be associated with a single data topic (e.g., “SELECT t1.c1, t1.c2 FROM t1 WHERE t1.c1>=15”), which may be referred to as a “normalized query.” In some embodiments, two or more queries that are normalized may have different the topic names (e.g., as a result of the different column order. Additionally, in some embodiments, a user may choose to treat query texts as entities without further normalization.

The database query aliasing algorithm utilized by the aliasing module 408 may determine a normalized query from a database query by parsing and building a syntax tree for the database query. Building the syntax tree may comprise inserting optional database query keywords (e.g., “COLUMNS”) into the syntax tree, and synonym keywords may be permitted but may be converted to their standard form (e.g., the German “UND” being a synonym for the English “AND”).

For example, for “SELECT t1.c2, t1.c1 FROM t1 WHERE 15<=t1.c1”, the aliasing module 408 may generate a syntax tree similar to the following:

```
SELECT
    COLUMNS
      t1.c2
      t1.c1
    FROM
      t1
  WHERE
      <=
        15
        t1.c1.
```

The database query aliasing algorithm utilized by the aliasing module 408 may further identify nodes for which children ordering is semantically unimportant for purposes of database performance analysis for those nodes (ordering may remain important for general-purpose SQL semantics). For those nodes identified, the aliasing module 408 may reorder children in alphabetical order; for identically named children, this reordering uses their own children as a secondary sorting key, and so on. This is what happens to the COLUMNS node in the example above.

The database query aliasing algorithm utilized by the aliasing module 408 may further identify nodes that can be remapped to a canonical or normal form, which preserves general-purpose SQL semantics. In the example above, this is what happens to the “<=” node, which is remapped to a “>=” node with its children swapped. In some instances, sub-queries may be turned into join nodes.

The database query aliasing algorithm utilized by the aliasing module 408 may further identify nodes that can be remapped to some common placeholder node(s) of equivalent semantics recognized by the data flow exploration system 200 (not necessarily by general-purpose SQL semantics). For example, all MAX and MIN nodes that are descendants of a COLUMNS node may be remapped into the MAXMIN placeholder node because the computation cost of both nodes is practically the same. In another example, a sub-query “SELECT 2*t2.c2 FROM t2” that operates on a small table “t2” may be remapped into “SELECT 1 FROM t2”, thereby only capturing the fact that the sub-query accesses table “t2” (and thus the outer query has “t2” as one of its indirect sources or tables) but none of the particulars. Consequently, it may be considered equivalent to a sub-query such as “SELECT 3*t2.c2 FROM t2”.

The database query aliasing algorithm utilized by the aliasing module 408 may further identify nodes that the aliasing module 408 deems to be semantically irrelevant, and discards them. For example, the aliasing module 408 may discard a LIMIT node in queries whose tables are of a small size.

Continuing with the example syntax tree from above, the syntax tree that results from the operation above may be as follows:

```
SELECT
  COLUMNS
    t1.c1
    t1.c2
  FROM
    t1
  WHERE
    >=
      t1.c1
      15
```

As described herein, coarse or refined parse trees may be generated and used in various embodiments, and may depend on the particular application. Accordingly, a system of some embodiments can handle data flows for queries that are mal-formed in some manner.

The database query aliasing algorithm utilized by the aliasing module 408 may finally convert the syntax tree into a string. The conversion may be facilitated by “walking” the syntax tree to produce the normalized query. Continuing with the latest version of the example syntax tree from above, the resulting normalized query may be similar to “SELECT t1.c1, t1.c2 FROM t1 WHERE t1.c1>=15”.

By grouping a set of database queries using a normalized query (e.g., generated by the aliasing module 408), the set of database queries can be appropriately associated with a data topic corresponding to the normalized query. As discussed herein, a data topic may define an equivalence class for the purposes of analyzing database data flows.

In alternative embodiments, the aliasing module 408 may perform a variant of the query aliasing algorithm described above, whereby references to columns that are considered irrelevant in the grouping may be dropped.

To perform database query aliasing, the aliasing module 408 may be implemented using a SQL parser that is less rigid than traditional SQL parsers. With a less rigid SQL parser, the aliasing module 408 may be able to understand a larger variety of data flows using a range of SQL dialects. According to some embodiments, the SQL parser of the aliasing module 408 may first attempt to locate broad elements present in all SQL queries (e.g., tables and columns) via a first pass over a database query captured from a database data flow. Subsequently, the SQL parser may perform one or more refined passes that delve into details (e.g., subclauses of the WHERE clause) when necessary. The layering of coarse and refined parsing may provide for a componentized parser that can be developed independently and be maintained at lower cost.

Failure to locate some part of the query does not necessarily result in a total failure for the SQL parser of the aliasing module 408. For example, if the portion of the database query that cannot be parsed is deemed to occur in a context that does not have semantic value (e.g., a constant literal when the choice of normalization algorithm is such that concrete constant values are discarded), then the parsing is still considered successful because the semantically relevant information was successfully retrieved. In doing this, the SQL parser of the aliasing module 408 may operate resiliently under environments where esoteric, in-house SQL dialects may be used, possibly with custom extensions unknown to the SQL parser.

The SQL parser of the aliasing module 408 may also be configured to automatically identify the SQL dialect applicable to a database query of a database data flow. This identification may occur during a coarse or refined pass by the SQL parser. Once the SQL dialect is identified, that information may be utilized by the SQL parser to re-parse those portions of the database query that failed the initial, standards-compliant, parsing pass. Additionally, or alternatively, once the SQL dialect is identified, that information may be utilized by the SQL parser to resolve ambiguities present in other portions of the database query (e.g., when a non-standard keyword is used by two different dialects with each assigning a different meaning to that same keyword). For instance, if the SQL parser detects a construct that is unique to the DB2 SQL dialect, it may label this construct as DB2-specific and then re-parse the database query of the database data flow, all while taking into account any other particularities of the DB2 SQL dialect. The DB2 label may also carry over to the database connection being monitored so that the aliasing module 408 may then parse future database queries of other database data flows on the same connection after assuming that the DB2 SQL dialect applies to them, thereby increasing the probability of successful and accurate parsing. A user at a data flow exploration client (e.g., 104) may also provide hints to the SQL parser of the aliasing module 408 on which dialect(s) is/are applicable on specific connection(s).

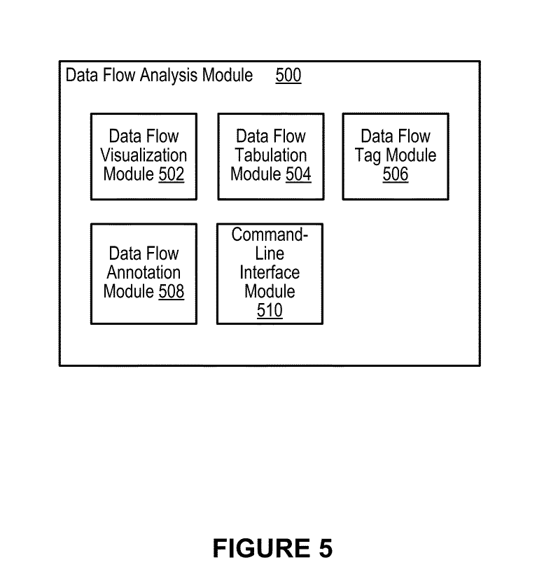

FIG. 5 illustrates an example data flow analysis module 500 in accordance with an embodiment of the invention. For some embodiments, the data flow analysis module 500 may be similar to the data flow analysis module 208 described above with respect to FIG. 2. As shown, the data flow analysis module 500 comprises a data flow visualization module 502, a data flow tabulation module 504, a data flow tag module 506, a data flow annotation module 508, and a command-line interface (CLI) module 510.

The data flow visualization module 502 may be configured to generate, provide, or otherwise facilitate a visual representation of a data flow captured and analyzed by a data flow exploration system (e.g., 200). In some embodiments, the visual representation may be in the form a graphical chart, such as a flow chart. For example, the data flow visualization module 502 may generate a Sankey diagram to visually present the data flows captured and analyzed. In some embodiments, the Sankey diagram may be presented to a user at a data flow exploration client (e.g., 104) through a graphical user interface provided by a data flow exploration system (e.g., 106). According to various embodiments, the Sankey diagram comprises lines between Sankey nodes, where the lines represent data flows and each Sankey node represents a grouping of data flow elements associated with a common tag (e.g., a common tag associated a group of data sources, data clients, or data topics). Accordingly, each Sankey node may treat multiple data sources (e.g., tables or databases), data flows (e.g., database queries or database query results), and data clients (e.g., users) as a single node of the Sankey diagram. The Sankey diagram may enable user interaction such that a user selection (e.g., click) on a tag (represented by a Sankey node) causes expansion of the tag to sub-tags (according to an associated tag hierarchy). In some embodiments, when a tag has more than a certain number of children tags, the Sankey diagram presented may automatically collapse those children tags into a single transient group node to improve visibility of other nodes, and thus improve diagram clarity. By visually presenting data flows through use of Sankey diagrams, the amount of data flow may be visually represented by the thickness of the lines connecting data sources to data flow topics to data clients, or their respective tag-based or transient groups. The data flow visualization module 502 may permit a user to select the amount of interest among several statistics or metrics, including for example, for database data flows, the number of queries, the execution time of queries, or the number of rows involved in a data flow. The amount of data flow for any metric can be adjusted by including or excluding sub-tags or entities under a Sankey node based on their name or other criteria. With a single tag hierarchy to represent multiple conceptual hierarchies, the resulting single Sankey diagram combines conceptually distinct (and complementary) selection criteria.

In various embodiments, the data flow visualization module 502 may speed up generation of visualizations, particularly for complex visualizations, using a mechanism that limits visibility of the Sankey diagram to a portion of the analysis information. The portion may be specified as the most recent n transactions prior to a date d, where both n and d are interactively specified by a user at a data flow exploration client (e.g., 104). The default values may be ‘now’ for d, and ‘infinity’ for n, thereby providing no visibility limits. In some embodiments, the n or d value, or both, may be automatically adjusted by the data flow visualization module 502 based on the responsiveness of the visualization (e.g., Sankey diagram) generated by the data flow visualization module 502 as the user of the data flow exploration client 104 interacts with the visualization; the responsiveness may be dependent on the loads of the system 106, client 104, and network 110.

To further speed up generation of visualizations, the data flow visualization module 502 may utilize caching of queries conducted against the data flow data store 206 while generating visualizations. The data flow visualization module 502 cache results of database queries the data flow exploration system (e.g., 200) performs, especially within the context of visual exploration. The cache may be shared between all visualization, tabulations, and tags. Additionally, the normalized form of each query may be used as the cache key. For instance, the SQL queries “SELECT x FROM y WHERE z=3 AND w=4” and “SELECT x FROM y WHERE w=4 AND z=3,” can be translated to the normalized form of “SELECT x FROM y WHERE z=3 AND w=4,” which can then be used as the cache key for the associated query results. This may prevents use of cache storage for unnecessary retention of identical, repeated results generated by database queries that are semantically identical. It may also reduce storage system resource usage as unnecessary computation may be avoided.

Depending on the embodiment, access to the visualizations generated by the data flow visualization module 502 (or possibly other components of a data flow exploration system 200), may require user authentication (e.g., by LDAP or Active Directory) or user credentials. More regarding visualization by Sankey diagrams is described later herein.

The data flow tabulation module 504 may be configured to generate, provide, or otherwise facilitate a table of information relating to data flows. In some embodiments, the table may be presented with, and synced with respect to, the visualization (e.g., Sankey diagram) provided by the data flow visualization module 502. Accordingly, adjustments (e.g., selections) performed with respect to a table provided by the data flow tabulation module 504 may result in corresponding adjustments being performed on the visualization provided by the data flow visualization module 502.

The table provided by the data flow tabulation module 504 may comprise a spreadsheet-like view of database users, database tables, and normalized queries, and associated metrics and statistics for database data flows. According to some embodiments, a subset of the information stored in the storage system may be shown at any one time. This subset may be controlled by a user of the exploration client 104 via filters, which appear over the table. The filters may represent the inclusion or exclusion of one or more entities or tags. Pagination may be another kind of filter which displays just a few table rows per page. A user of the exploration client 104 may also sort the information shown by any table column. Depending on the embodiment, the table provided may take one or several forms, including: where individual rows correspond to any of the entity types (e.g., database users, normalized queries, database tables); and where other entities are summarized. For example, the database-table-centric form may have a column that shows the total number of database users who have conducted queries against the database table depicted on each row. The user of the exploration client (e.g., 104) may then click on such a number, say for the row associated with database table “t1”, to switch to a database-user-centric view, filtered by database table “t1”. Or, the user of the exploration client (e.g., 104) may click on a tag (tags are shown alongside each entity, within its row) which is thus added to the list of table filters. More regarding tabulation of data flows is described later herein.

The data flow tag module 506 may be configured to facilitate tagging of an element of a data flow with a tag. As discussed herein, a tag may be a text-based label or keyword associated with a data flow (as a whole) or elements associated with a data flow. Elements of a data flow that may be tagged may include, for instance, one or more entities (e.g., data sources, data topics, or data clients) associated with the data flow, or one or more annotations associated with the data flow. Once one or more elements are associated with a tag, those elements may be grouped, located, sorted, filtered, or otherwise acted on based on/according to the tag.

Tags may be organized in a directed acyclic graph (DAG) where each tag has a parent and possibly has children tags. As such, in some embodiments, tags can represent organizational structures, such as the division of users across departments. For example, a tag “Company” may have children tags “Engineering” and “Legal”, and “Legal” may have children tags “Patent” and “Tax”. Tags may also represent geography (e.g., first level being a continent, next a country, and so on), workflow (e.g., a shallow hierarchy with one top-level “Workflow” tag and multiple children such as “Pending”, “Approved”, and/or “Audited”), or, for tags applied to queries, the software application and/or its module that issued the query (e.g., “Billing”, “Email”, “Analyzer”, “Visualizer”, with the latter having children tags “Pie chart” and “Bar chart”).

For some embodiments, two or more different tags may have the same textual label. For instance, “Bob's team” may be the label for two different tags in the tag hierarchy, one under “Tax” for Robert Jones' team, and one under “Patent” for Robert Smith's team. The only constraint on tag labels that may be imposed by the data flow tag module 506 may be that no two tags that share a parent may have the same label.

When presented through a user interface, tags may be presented such that a user can tell apart tags with identical textual labels. For instance, every tag may be presented via its own label but, when a user moves (e.g., hovers) a cursor, mouse cursor, or the like over a given label, a graphical balloon showing the hierarchy may be presented with the given label highlighted within the hierarchy. In some embodiments, a script may access or refer to a tag using a combination of a tag's label and those of its parent tags if present (e.g., use “Company:Legal:Patent:Bob's Team” to refer to a tag “Bob's Team,” which is a child of a tag “Patent,” which is a child of a tag “Legal,” which is a child of a tag “Company”).

A given entity may be associated with zero or more tags. For instance, in addition to the department hierarchy, a user of the exploration client 104 (e.g., an HR manager) may create a separate hierarchy where tags represent employee performance, such as “Top 10%—bonus”, “Middle 80%—stable”, “Bottom 10%—reassign”. For example, the user Sue may be both tagged as “Bob's team” as well as “Top 10%—bonus”. Additionally, where tags are organized as a DAG, a tag may have more than one parent. Additionally, where tags are organized as a DAG, a tag may have more than one parent. For example, the tag “Top 10%—bonus” may have two parent tags, “Most recent rankings” and “2013 rankings,” where the former tag contains only the latest rankings (therefore its children set changes after every performance review cycle) and the latter tag retains a historical record of past rankings (i.e., its children set does not change). Accordingly, a given tag hierarchy does not have to be represented as a strict tree.

In various embodiments, tags may be associated with access permissions (e.g., access control lists). In some embodiments, only certain authorized users may create children of a private tag. In some embodiments, the identity of the user who created a tag may be tracked, stored, and later displayed or used in further computation, such as a trigger execution.

As discussed herein in further detail, tag creation or association through the data flow tag module 506 may involve an explicit user interface action by a user, or occur automatically via script-based analysis (which may evaluate data flow analysis results). For example, a script created by a user may execute and thus analyze the known database tables, normalized queries, and database users of a database data flow, and tag them as follows: tag database users who have executed the most time-consuming queries as such; tag the normalized queries or database tables which produce the heaviest flows (e.g., highest number of bytes) as such.

Tags created via script-based analysis may not be different than any tags created via other means. Uniform treatment of all tags implies in part that, where tags are organized as a DAG, tags created via script-based analysis may be preserved via adoption, which is the assignment of an additional parent tag to a tag. For example, consider a script that creates the tag “Usage Script,” a tag “Execution” that is a child of “Usage Script,” and tags “Top 10%”, “Middle 80%”, and “Bottom 10%” that are children of “Execution.” The script may then apply exactly one of these three (leaf) tags to each database table in a database data flow. The second time the same script runs, the tag “Usage Script” may disown its “Execution” child (meaning that it removes it from its children set), which may result in the tag being removed (as it has no parent claiming it), its three children being removed (as they have no parent left), and all tables that were tagged using the children being untagged. Subsequently, the script may create new tags under the same name: tag “Usage Script”; a child tag “Execution”; and children tags, “Top 10%”, “Middle 80%”, and “Bottom 10%”. In the event that the user wishes to retain the original “Execution” tag, the user may have a “History of Usage Script” tag adopt the original “Execution” tag prior to the second run of the script. By doing so, the “Execution” tag may not be removed during the second run because the “Execution” tag would still have one parent claiming it after “Usage Script” tag disowns it. In the event that the user wishes to retain the original “Execution” tag, the user may have a “History of Usage Script” tag adopt the original “Execution” tag prior to the second run of the script. In doing so, the “Execution” tag may not be removed during the second run because the “Execution” tag would still have one parent claiming it after its “Usage Script” tag disowns it.

A given tag may be disassociated from (e.g., “disowned by”) a parent tag. If a given tag ends up being inaccessible (e.g., it has no parent tags), then it may be automatically removed from the data flow exploration system (e.g., 200). For some embodiments, the removal of a given tag may cause those among its children tags which have no other parent tags to be removed as well, as they also may become inaccessible. The same may occur for any descendant tags of these children tags. Any entity in the data flow exploration system (e.g., 200) associated (e.g., tagged) with a tag that is removed is then disassociated from that tag. To guard against inadvertent removal of tags, the data flow exploration system (e.g., 200) may control a user's permission for removing a tag or disassociating (e.g., disowning) a tag (e.g., from an entity) and may further require levels of confirmation before a tag is removed or disassociated (e.g., a “Recycler” or “Trash” bin for capturing disowned tags).

The data flow annotation module 508 may be configured to annotate one or more elements of a data flow, where the elements may include any entity of the data flow or the data flow itself. For some embodiments, the annotation may be utilized to capture what may be referred to as “(human) institutional knowledge” about data flows. The annotations may be notes or generic documents accessible or editable through a data flow exploration system (e.g., 200). Every element (e.g., entity) of a data flow may be associated with zero or more annotations. Additionally, each annotation may contain a back-link (e.g., a URL) to the data flow exploration system (e.g., 200) and pointing to a page describing the element (e.g., entity).

Consider for example, a database data flow where table “t1” is associated with an annotation that may contain the text “t1 stores the addresses of clients”. The annotation may also contain a clickable link which, if selected, directs a user at a data flow exploration client (e.g., 104) to a page where the information displayed is filtered to include only that pertaining to table “t1”.

The annotations may be stored or implemented using another subsystem, such as a third-party wiki or collaborative document system. Additionally, the annotations may be stored or implemented alongside other documents that reside on the other subsystem. The integration of a subsystem may facilitate seamless transitions between the data flow exploration system (e.g., 200) and the subsystem. For various embodiments, a command-line interface (CLI) may be utilized to manage annotations.

Users may reference other users within annotations, with the referenced user receiving a notification (e.g., via email, text message, or instant message) that they have been referenced in an annotation. Users can also choose to receive notifications when certain annotations of their choosing are modified.

In certain embodiments, a text string may be used as a keyword in filtering visibility of data flows depicted in a visualization (e.g., in a Sankey diagram), based on the content of annotations associated with elements of the data flows. The annotations may, for some embodiments, facilitate collaboration between two or more users accessing the data flow exploration system (e.g., 200).

The command-line interface (CLI) module 510 may be configured to provide a command-line interface (CLI), which may facilitate execution of a set of commands that perform data flow related operations. For example, a user may utilize the CLI command “cli addTag Top:Child” to create the tag “Child” as a child of the “Top” tag. In another example, a user may utilize the CLI command “cli for i in range(10) cliAddTag(“Top:Child”+str(i))” to create 10 children tags of the “Top” tag, named “Child0” through “Child9.” For some embodiments, the command-line interface (CLI) may enable creation and subsequent execution of a script that causes a data flow exploration system (e.g., 200) to perform data flow operations. For instance, a sequence of CLI commands can be stored into a script file and then executed by the CLI as needed. For some embodiments, the CLI may be used via a terminal screen. In some embodiments, the CLI may be used via a web-based interface that provides a text box in which CLI commands may be typed and executed. The CLI may support a mix of custom CLI commands interspersed with programming language constructs of a standard programming language, such as Python, Perl, or the like. In some embodiments, the CLI module 510 may be utilized to perform non-analysis operations with respect to the data flow exploration system (e.g., 200), and may perform such operations in addition to or in place of analysis operations.

For some embodiments, the CLI module 510 may implement the CLI using existing interpreters, such as Jython, which is a Python interpreter implemented as a Java package. With such use of the Java interpreter as the foundation under the Python interpreter, operations performed by Jython in response to commands received through the CLI may be constrained to a Java sandbox, thereby constraining Jython's access to the computing device executing the Java interpreter on behalf of the CLI module 510. The computing device executing the Java interpreter on behalf of the CLI module 510 may not be the same as a computing device (e.g., client device) accessing the CLI (e.g. in a client/server model). In some embodiments, the CLI module 510 may implement the CLI using Jruby, which is a Java implemented Ruby interpreter. In various embodiments, the CLI module 510 may enable the execution of an arbitrary shell command (e.g., in a manner analogous to system( ) in PERL) to facilitate script based interaction with the flow analysis module 500.

Depending on the embodiment, the CLI module 510 may facilitate script execution such that if any command in the script fails to complete, all the commands in the script are treated as if they had not been executed. This may be implemented by having the script execution occur inside a database transaction of a database embedded within the data flow exploration system (e.g., 200), and having that transaction rolled back if the script does not complete successfully.

In some embodiments, the CLI module 510 may provide or otherwise implement an interactive console through which a user can enter and execute commands (e.g., in Jython or Jruby) with respect to the data flow exploration system (e.g., 200). In doing so, the interactive console can allow a user to interactively execute commands, gauge the outcomes of those commands, and decide which commands they would like to invoke (e.g., in a script). In various embodiments, the CLI module 510 may also provide or otherwise implement an integrated development environment (IDE) through which scripts operative with the data flow exploration system (e.g., 200) can be authored or edited. Scripts that are authored, uploaded or otherwise saved to the data flow exploration system (e.g., 200) may be incorporated into a script library, which may provide a user of the data flow exploration system with access to those scripts during future sessions, and which may allow the user to share the scripts with other users of the data flow exploration system (e.g., for collaborative use or development of scripts).

In some embodiments, one or more web services are implemented to provide remote access to various features described herein by clients. For example, a client may use the HTTP protocol and messages exchanged in the JSON format to communicate with a server that provides one or more web services implementing access to various features described herein. In another example, a client executing a script (e.g., from a command-line or as part of an unattended batch execution) that generates HTTP-based messages (e.g., similar to curl) can remotely access (e.g., over a network connection) features provided through one or more web services implementing access to various features described herein. As a further example, a client may remotely execute a script by submitting the script (e.g., in JSON form and via the HTTP protocol) to one or more web services implementing various features described herein.

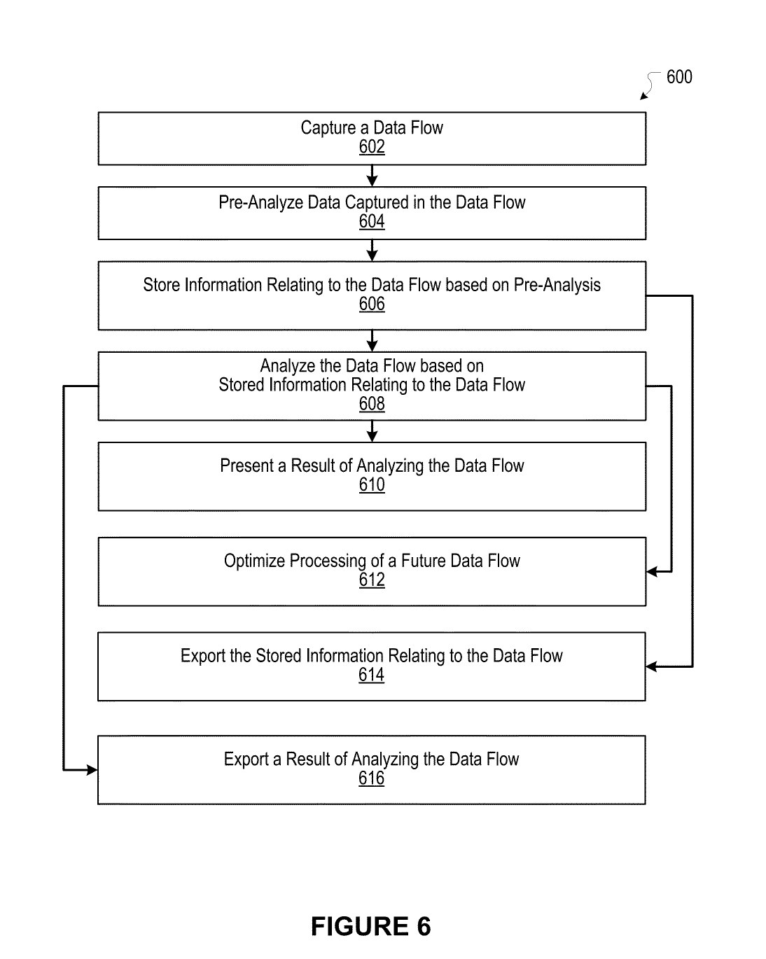

FIG. 6 illustrates an example process 600 for analyzing data flows in accordance with an embodiment of the invention. In some embodiments, the data flow analysis process 600 may be performed in whole or in part by the data flow exploration system 200 described herein. For some embodiments, the process for analyzing data flows may perform more or less operations than what is illustrated in FIG. 6, and may perform the operations illustrated in FIG. 6 in an order different than the order shown.

At block 602, a data flow between a data source and a data client is captured. In various embodiments, the capturing of the data flow may be facilitated by a data flow capture component (e.g., the data flow capture module 400), which may capture the data flow by way of pulling data from a data source, receiving data pushed from a data source, or functioning as a proxy for a data flow between a data source and a data client. Other embodiments may utilize additional or alternative methods for retrieving or capturing data from data flows between data sources and data clients.

At block 604, data in the data flow is pre-analyzed. For some embodiments, the data pre-analyzed may be from the data flow captured at block 602. Pre-analysis of the data may comprise extracting, deducing, or otherwise producing information, relating to the data flow, from the data. For instance, where the data flow captured relates to e-mails processed by a given e-mail server, the pre-analysis of the e-mail data captured in the data flow may result in data flow information that identifies e-mail sender(s), identifies e-mail recipient(s), identifies related e-mails (e.g., e-mail threads), and provides various metrics regarding the e-mails, such as their data size (e.g., number of bytes), number of attachments, types of attachments, and transmission/receipt timestamps. Information produced by pre-analysis of the data may include, for example, one or more entities (e.g., data source, data topic, or data client) involved in the data flow (captured at block 602), one or more tags (automatically or manually) associated with the data flow, or one or more annotations associated with the data flow. In some embodiments, the extraction or deduction of information may include computing relevant metrics for the data flow. Once computed, the metrics may be included as part of the information regarding the data flow (also referred to herein as “data flow information”).

At block 606, information relating to the data flow is stored. For some embodiments, the information relating to the data flow may be produced during the pre-analysis of data in the data flow at block 604. Storing the information relating to the data flow may comprise storing the information to, or retaining the information in, a persistent data storage system, such as a relational or non-relational database system (e.g., PostgreSQL), one or more files on a file system (e.g., comma-separated-values [CSV] files), or a document storage system (e.g., Etherpad, or a Wiki). The persistent data storage may utilize a computer readable medium to facilitate storage of the information.

Once stored, the information relating to the data flow may be organized in a manner that facilitates subsequent data flow analysis, exportation of the information (e.g., to third party systems or services external to the process), or optimization of data flow processing. For example, in various embodiments, cache database tables may be utilized to store a whole or partial copy of data flow information from source database tables (e.g. other database tables that are part of the same storage system as the cache database tables). The copied data flow information in the cache database tables may be reorganized in a manner that improves analysis speed for various steps of the data flow analysis process, and may be recompiled automatically when the source database tables are modified. Example data flow analysis processes that can be improved by cache database tables include those relating to interactive visualization of data flow analysis results.

At block 608, the data flow is analyzed based on the information relating to the data flow. For some embodiments, the information relating to the data flow may be the information produced at block 604 and stored at block 606. Depending on the embodiment, analysis of the information relating to the data flow may permit a user (e.g., human operator) or software system (e.g., third party software system) to gain a detailed understanding of the data flow between the data source and the data client. In various embodiments, analyzing the information relating to the data flow may comprise: providing the information relating to the data flow (e.g., in raw or formatted form) for user viewing, generating interactive or non-interactive visualizations of the information relating to the data flow (e.g., Sankey diagrams); providing features that organize the information relating to the data flow (e.g., grouping with tagging, summary statistics, tabulation, etc.); identifying data patterns for the data flow (i.e., data flow pattern detection, using descriptive statistics, such as average, variance, etc.) based on the information relating to the data flow; manual or automatic tagging of data flows using the information relating to the data flow; annotation of data flows (or data flow entities) using the information relating to the data flow (e.g., by adding to the information); and performing analysis of the information relating to the data flow using a script or a command-line interface (CLI). When analyzing the data flow based on the information relating to the data flow, the analysis can consider information as data tags, annotations, and entities involved with respect to the data flow. In some embodiments, the data flow pattern detection can include detecting cyclical/periodical events, such as a correlation between the running times of queries getting slow whenever the time-of-day of their execution overlap.

At block 610, a result of analyzing the data flow, based on information relating to the data flow, is presented. For some embodiments, the result presented may be provided by way of analysis of information relating to the data flow at block 608. As described herein in further detail, analyzing the information relating to the data flow may comprise providing the information relating to the data flow for user viewing or, more specifically, generating interactive or non-interactive visualizations of the information relating to the data flow. Accordingly, in some embodiments, presenting the result of analyzing the data flow may include presenting the information relating to the data flow to a user, or presenting a generated visualization of the information relating to the data flow, for viewing by a human user (e.g., through a web-based interface). For some embodiments, an interactive visualization of the information relating to the data flow may enable a user to view a visual representation of the data flow (e.g., from the data source to the data client) and interact with the visual representation. Example user interactions with respect to the visualization may include grouping or filtering data flows presented in the visualization. Through such user interactions, a user may for instance group e-mail data flows presented in a visualization according to e-mail senders or according to organizational departments. In doing so, a user may be able to determine how many e-mails a particular e-mail sender or organizational department has sent (e.g., over a given time period).

In various embodiments, the presentation of a generated visualization may be facilitated through a graphical user interface (GUI) presented to the user. Additionally, the GUI may facilitate exploration and analysis with respect to a generated visualization. Depending on the embodiment, the GUI may be implemented as a web-based interface (e.g., an AJAX-based interface), a user interface of a stand-alone application, or the like.

At block 612, processing of a future data flow is optimized. In various embodiments, the optimization may be based on analysis of the information relating to the (accumulated current or past) data flow, which may be performed at block 608.

Depending on the embodiment, application-program interfaces (APIs) may be provided that facilitates exportation of the information to processes external to the data flow analysis process 600. For example, an external process, implemented by way of an external analysis script, may use an API to retrieve the information relating to the data flow and stored at block 606.

At block 614, the information relating to the data flow is exported. For some embodiments, the information exported may be the information stored at block 606. In some embodiments, the information may be exported for use outside the data flow analysis process 600. For example, the information relating to the data flow may be exported to software external to the data flow analysis process (e.g., third party software), which a user may utilize for additional analysis or reporting purposes. Additionally, in some embodiments, exportation of the information relating to the data flow may comprise providing the information in a well-defined format (e.g., CSV or XML file), where the format may facilitate use of the information by processes independent to the data flow analysis process 600. In this way, the data flow analysis process 600 may make the information available for use by various query engines.

At block 616, a result of analyzing the data flow is exported. For some embodiments, the result exported may be the result produced by the analysis of the data flow at block 608. In certain embodiments, the exportation of the result may comprise exporting a (static) copy of a visualization generated during the analysis of the data flow. Additionally, in some embodiments, the exportation of the result may comprise generating or otherwise providing a link (e.g., universal resource location [URL]) to the result. Such a link may permit a system or process external or independent to the data flow analysis process 600 to access the result. For example, where the result is exported in the form of a link, a web-based wiki system that is external and independent to the data flow analysis process 600 may include the link in the content of a wiki page, or use the link to incorporate a copy of the results into content of the wiki page (e.g., incorporate a copy of a screenshot of the data flow visually represented in the linked result).

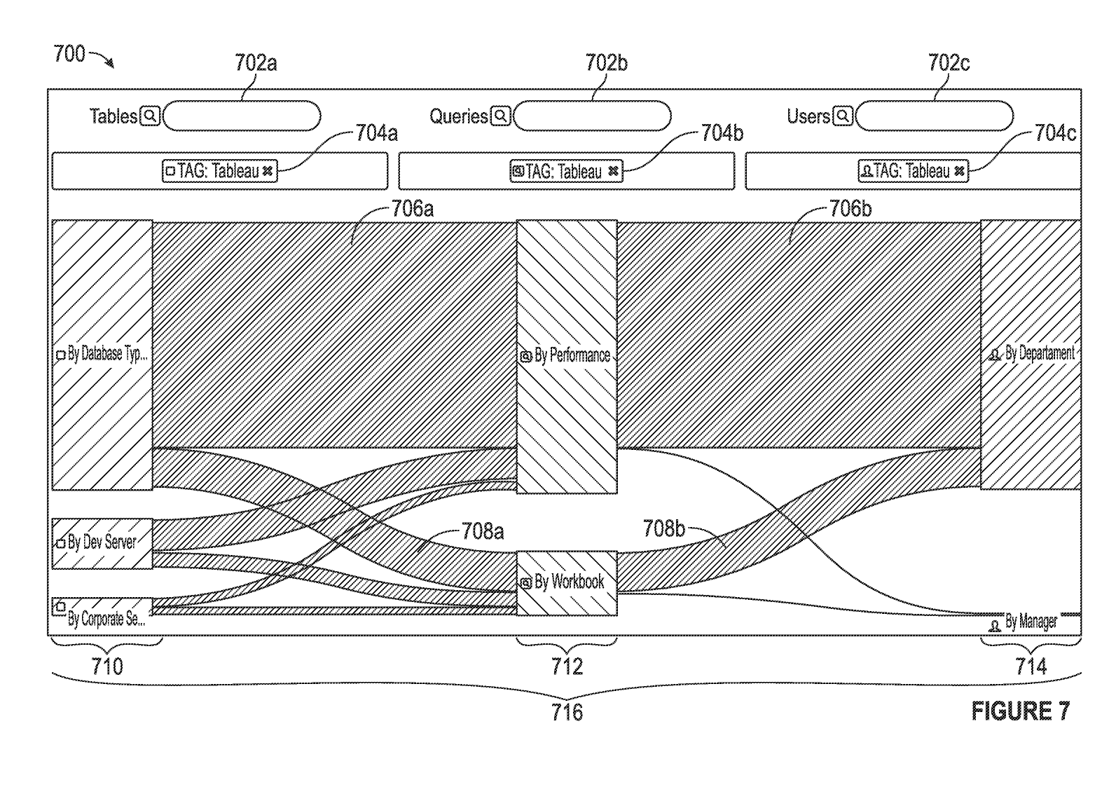

FIG. 7 provides a screenshot 700 of a Sankey diagram 716 generated to visualize multiple database data flows between database tables functioning as data sources and database users serving as data clients. Depending on the embodiment, the Sankey diagram 716 may be generated to be a static visualization of the data flows, or generated to be user interactive, whereby user interactions can result in dynamic changes to the Sankey diagram 716. According to some embodiments, the Sankey diagram depicted may be generated by way of the data flow visualization module 502 described in FIG. 5.

As shown, the Sankey diagram 716 comprises lines 706 and 708 representing the path of the database data flows and nodes 710, 712, and 714 representing entities grouped according to tags (e.g., parent tag or a child tag). In particular, the nodes 710 represent groupings of database tables that provide the data for the data flows. The groupings of database tables include the parent tags relating to “By Database Type,” “By Dev Server,” and “By Corporate Server.” The nodes 712 represent the data flows grouped according to tags associated with the database queries that generate the data flows. The lines 706a and 708a are representative of database data flows (and the amount of database data flowing) from tables grouped according to tags relating to “By Database Type” tags. While the line 706a is representative of database data flows (and the amount of database data flowing) associated with (e.g., generated in response to) database queries grouped together based on “By Performance” related tags, the line 708a is representative of database data flows (and the amount of database data flowing) associated with (e.g., generated in response to) database queries grouped together based on “By Workbook” related tags.

The nodes 714 represent the groupings of database users that are receiving data from the data flows. The lines 706b and 708b are representative of database data flows (and the amount of database data flowing) to database users grouped according to tags relating to “By Department.” While the line 706b is representative of database data flows (and the amount of database data flowing) associated with (e.g., generated in response to) database queries grouped together based on “By Performance” related tags, the line 708b is representative of database data flows (and the amount of database data flowing) associated with (e.g., generated in response to) database queries grouped together based on “By Workbook” related tags. For some embodiments, those entities (e.g., data sources, data topics, or data clients) that lack an association with any tags may grouped in the Sankey diagram 716 as untagged (e.g., “Untagged Tables,” “Untagged Queries,” or “Untagged Users”).

As described herein, the thickness of the lines 706 and 708 may visually provide a measurement associated with one or more data flows represented by the lines 706 and 708. In some embodiments, the thickness may be proportional to the measurement value (e.g., thickness increases as measurement value increases). Examples of measurements represented by the thickness may include, without limitation, execution count, total execution time, average execution time, standard deviation execution time, number of rows returned, average number of rows returned, standard deviation number of rows returned, number of errors, average number of errors, standard deviation number of errors, size of data, average size of data, and standard deviation size of data. The system may apply a class of aggregation or transformation operators (e.g., average, standard deviation, etc.) to the underlying metrics independently, depending on user choice, configuration, or other means. In other embodiments, visual characteristics of the lines, which can include thickness, style, color, and the like, may serve as visual representations of a measurement value with respect to the data flows the lines represent.

In FIG. 7, a user at data flow exploration client (e.g., 104) may utilize search fields 702a, 702b, and 702c to search for and select tags with respect to the Sankey diagram 716. In particular, a user may use the search field 702a to perform a text-based search for a tag and select from the search results a tag with respect to the database tables. Similarly, a user may use the search field 702b to perform a text-based search for a tag and select from the search results a tag with respect to the database queries. Likewise, a user may use the search field 702c to perform a text-based search for a tag and select from the search results a tag with respect to the database users. In some embodiments, selection of a tag with respect to a group of entities (e.g., all database tables, all database queries, or all database users) may have the effect of filtering out those entities represented in the Sankey diagram 716 (e.g., adjusting the nodes and lines to reflect the filtering of entities) that are not associated with the selected tag. When a tag is selected in the Sankey diagram 716 for the database tables, the database queries, or the database users, the selected tag may be displayed in tag-based filter fields 704a, 704b, and 704c respectively. When a tag has not been selected with respect to a group of entities (e.g., database tables, database queries, or database users), the corresponding tag-based filter field 704 may remain blank. Additionally, when a tag has been respectively selected in more than one of the groups of entities (e.g., a tag has been selected for database tables and another tag has been selected for database users), the Sankey diagram 716 may depict the lines and nodes to reflect the data flows according to the compound selection of tags. For example, in FIG. 7, the Sankey diagram 716 reflects the filtering of each of the database tables, the database queries, and the database users based on the selection of the tag “Tableau” for each (e.g., as indicated in tag-based filter fields 704a-704c).

In some embodiments, a user may: (a) select an entity instead of a tag, that limits the visualization to only data flows that pertain to the selected entity; or (b) select multiple tags or entities for each entity type and may craft a Boolean expression specifying how these multiple selected tags or entities affect the data flows visualized: (e.g., for tags A, B, and C, the user may wish to limit visualized data flows to only those for which the expression A AND (B OR C) holds true, or for which expression: (NOT A) AND B hold true). When more than one expression has been defined across the three different fields 704, the compound specification of expressions may determine the lines and nodes shown on the Sankey diagram 716. In some embodiments, the Sankey diagram 716 may show two columns by choosing to display or hide columns (and its associated entity type). For example, the database queries may be hidden from view, and the data flows may be visualized as connecting data sources to data clients directly.

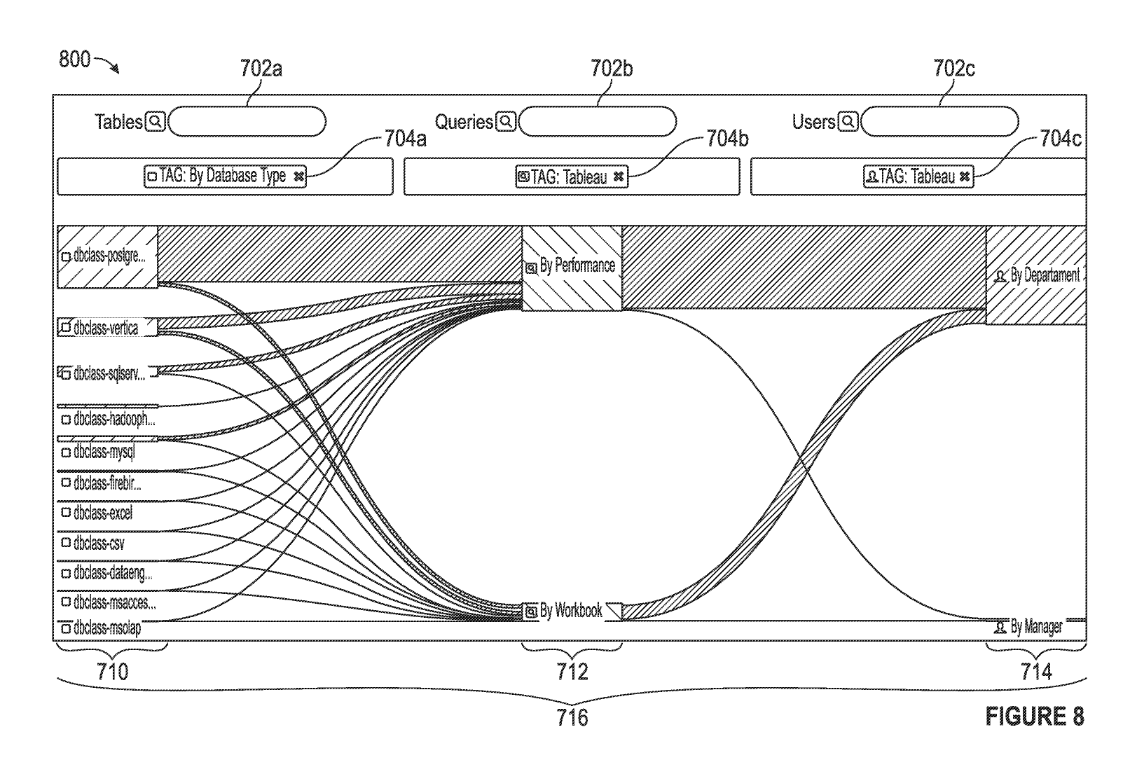

As described herein, in some embodiments, the tags may be organized according to a tag hierarchy. Where the selected tag is part of a tag hierarchy, the entities not associated with the selected tag may be filtered out of the Sankey diagram 716 (e.g., adjusting the nodes and lines to reflect the filtering of entities), and the selected tag may be expanded with respect to the group of entities associated with the selected tag (i.e., the group of entities not filtered out). Expansion of the selected tag with respect to the group of entities not filtered out may comprise dividing that group of entities into entity sub-groups according to sub-tags associated with and expanding from the selected tag. When this occurs, the nodes 710, 712, and 714 are adjusted to reflect the sub-grouping of entities in accordance with the sub-tags of the current selected tag (which may be indicated in one of the tag-based filter fields 704a-c).

Where a user has selected multiple tags/entities for an entity type, and crafted a Boolean expression comprising said tags/entities to filter the data flows visualized, the user may also specify one of those tags (e.g., A, B, or C) to be the at the “top” of their visualization (e.g., the tag whose sub-tags are shown as nodes 710, 712, or 714). As described herein, the selection of the top tag for visualization may not be the only filter upon visualized data flows. For example, as noted above, a Boolean expression provides for an additional level of filtering. For instance, with reference to FIG. 8, the user may be visualizing the sub-tags of “By Database Type” (the top tag) as shown in screenshot 800 and additionally exclude all “dbclass-vertica” flows (in which case that node may disappear from 710). The example Boolean expression used in such a case would be “By Database Type” AND NOT “dbclass-vertica”. Alternatively, the user may exclude both “dbclass-vertica” and “dbclass-csv” data flows (in which case both of these nodes may disappear from 710). The example Boolean expression would be “By Database Type” AND NOT (“dbclass-vertica” OR “dbclass-csv”). Further, the user may include only “dbclass-excel” data flows (in which case all other nodes may disappear from 710). The example Boolean expression would be “By Database Type” AND “dbclass-excel”.

To illustrate, FIG. 8 provides a screenshot 800 of the Sankey diagram 716 once a particular tag associated with a tag hierarchy is selected for the database tables. In particular, the screenshot 800 reflects the Sankey diagram 716 when a “By Database Type” tag is selected and expanded (in accordance with a tag hierarchy) to associated sub-tags of “dbclass-postgres,” “dbclass-vertica,” “dbclass-sqlserver,” “dbclass-hadoophive,” “dbclass-mysql,” “dbclass-firebird,” “dbclass-excel,” “dbclass-csv,” “dbclass-dataengine,” “dbclass-msaccess,” and “dbclass-msolap.” As shown, the tag-based filter field 704a is updated to reflect the selection of the “By Database Type” tag. Additionally, the nodes 710 representing database tables are grouped according to the sub-tags of the “By Database Type” tag. Additionally, the lines representing the data flows between database tables and database users through database queries are also adjusted in the Sankey diagram 716.

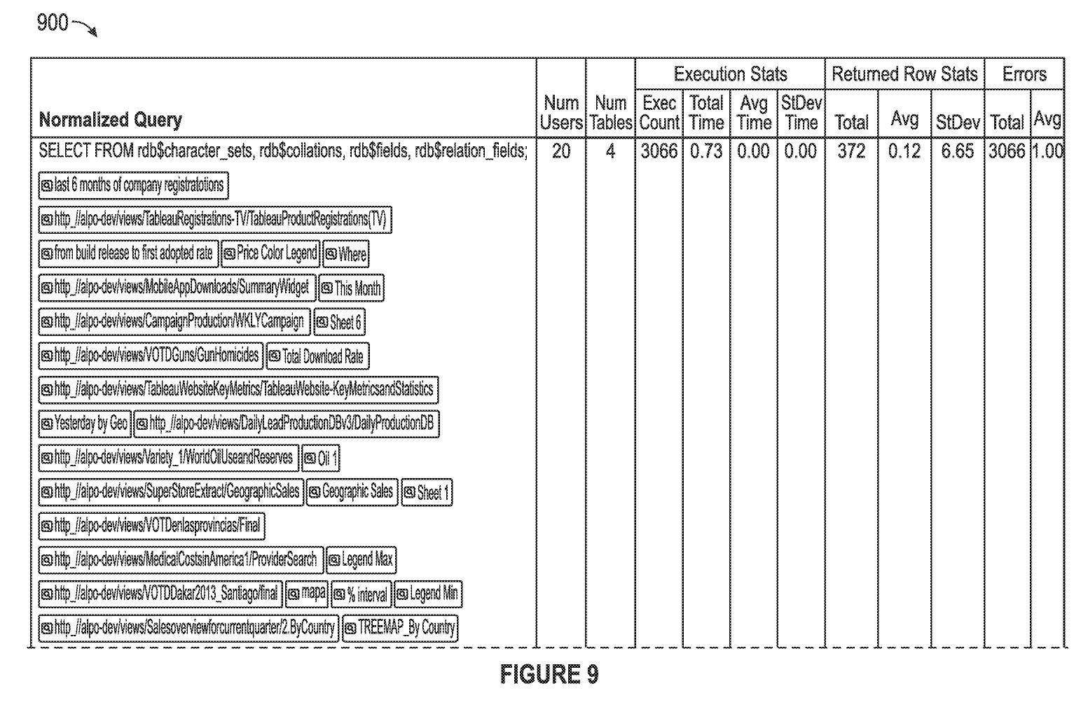

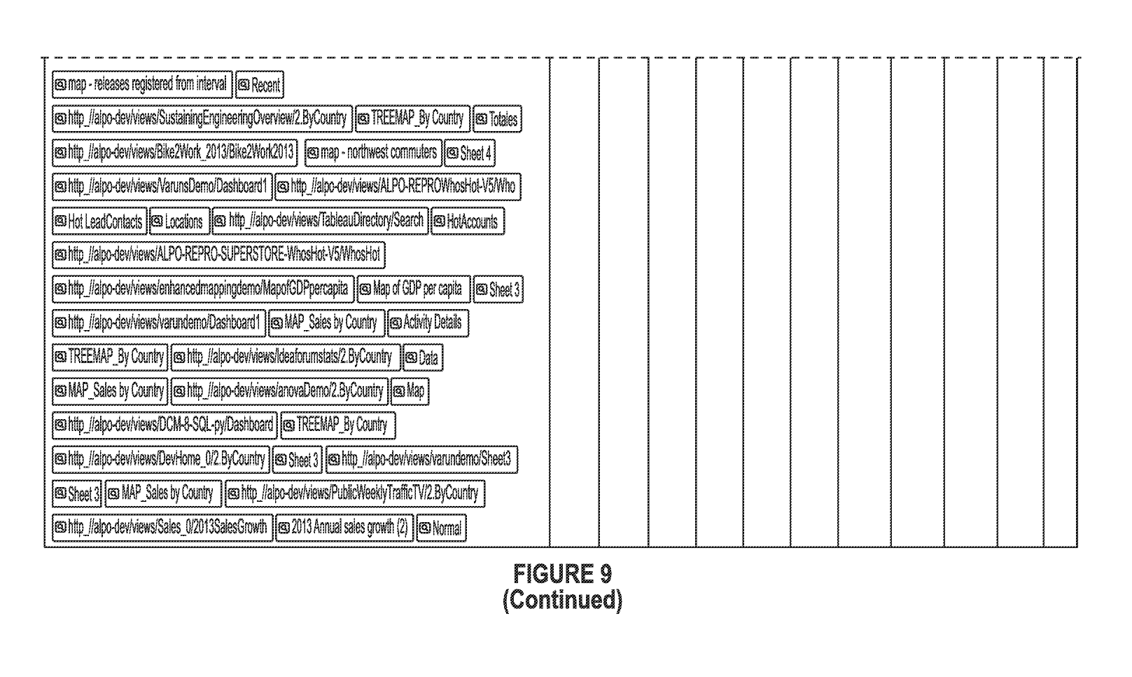

FIG. 9 provides a screenshot 900 of a table (also referred to as a “tabulated view”) including detailed measurements in regard to a normalized query relating to a database data flow. In accordance with some embodiments, the table depicted may be one generated by the data flow tabulation module 504. As described herein, the table may or may not be presented separately from another visualization of the data flow (e.g., Sankey diagram). Where the table is presented with another visualization, the table may be synchronized with the other visualization such that the information presented is relevant or at least associated with the data flows depicted in the visualization.

In some embodiments, the table depicted in the screenshot 900 may be presented in conjunction with a Sankey diagram (e.g., 716). For example, the table and a Sankey diagram for data flows may be presented through a common web page interface. When the table is presented in conjunction with a Sankey diagram, the information that they each display may be derived from a common subset of data flow transactions. The common subset may be affected by the choice of filters and viewports. For example, a user may choose a subset of database data flows (e.g., relating to SQL query transactions) such that each database data flow in the selected subset: (a) has at least one of its queried Tables tagged by “dbclass-sqlserver”, or by any of its descendants such as “db-ALPO”; (b) has its associated normalized Query tagged by “Normal” (which happens to have no descendants); and (c) “builder” as its associated user. With the selection of a subset of database data flows, tabulated view and a Sankey diagram can serve as two visualizations for the database data flows

The table in screenshot 900 depicts one normalized query, “SELECT FROM rdb$ . . . ,” that has been tagged by many tags, among them “Oil 1” and “Sheet 1.” For this particular dataset, which relates to database data flows in a server, these tags may mean that the normalized query was encountered in the context of creating a chart named “Oil 1,” and when creating a chart named “Sheet 1.” Though the normalized query is not shown as tagged by “Variety_{—}1,” an ancestor tag of “Oil 1,” (e.g., because no such direct tagging has taken place), if a user were to set the viewport (e.g., the Sankey diagram 716) to the tag “Variety_{—}1,” then the normalized query would still be included in the resulting flows, and therefore in the tabulation of normalized queries, thereby resulting in its row showing the set of tags shown in the screenshot 900.

In some embodiments, the table can present different types of information with regard to the data flows. For example, under a user-oriented view, the table may summarize all the data flows, in the selected subset, grouped according to users associated with those data flow. In another example, under a tables/query-oriented view, the table may summarize all the data flows, in the selected subset, grouped according to normalized query. The table depicted in screenshot 900 depicts an example of a table under a query-oriented view. In another example, under an error-oriented view, the table may summarize all the data flows that encountered an error, which may grouped according to the error code. In yet another example, a transactions detail-oriented view, the table may list of all the data flows in the selected subset of data flows.

Depending on the embodiment, the rows displayed in the table may be such that one row represent one user, table, normalized query, or error. For entities, the table may show all related tags in the same row as the entity. For example, for a “builder” user, we may show the “All Users” tag.

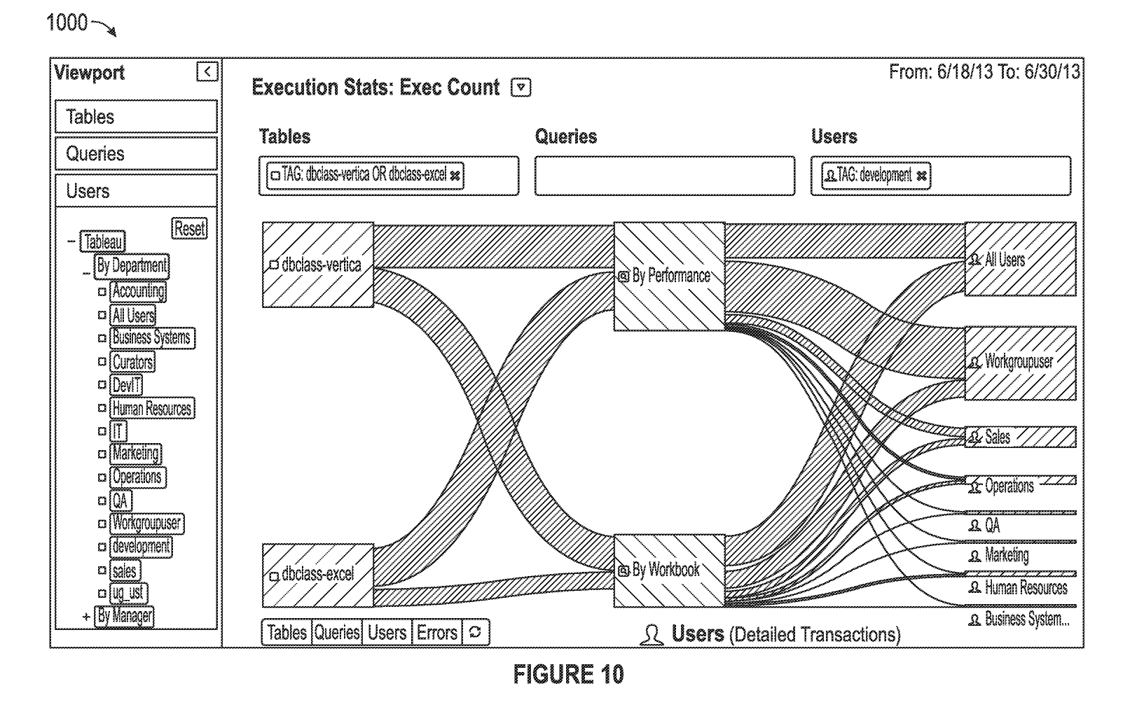

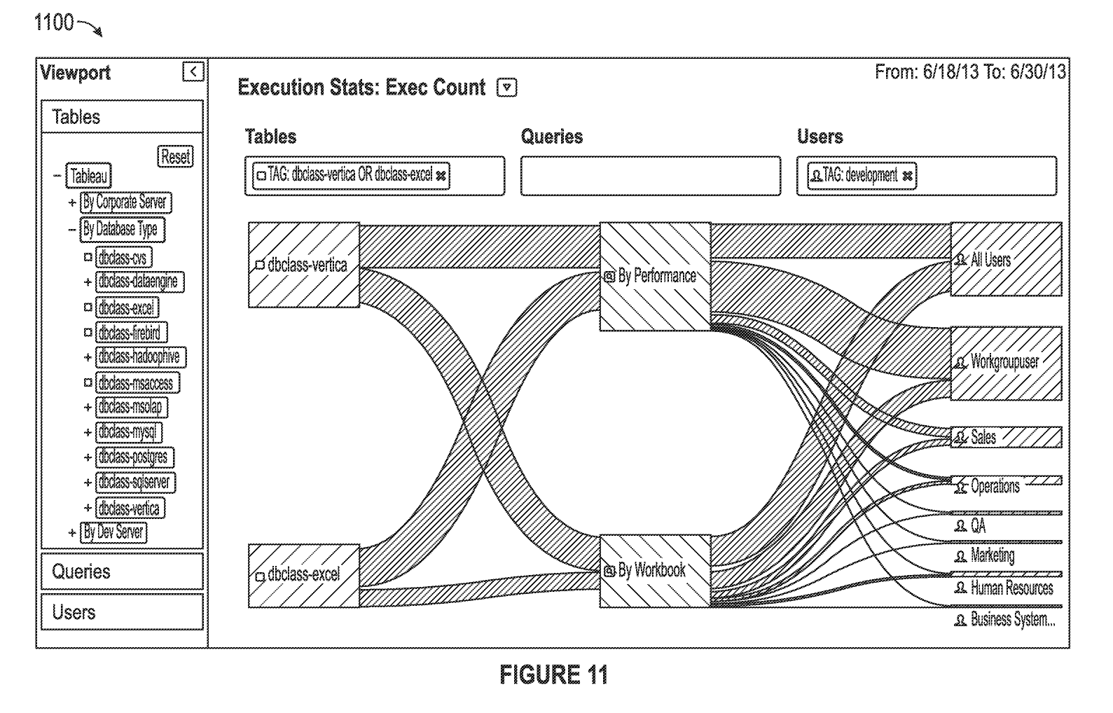

FIGS. 10 and 11 respectively provide screenshots 1000 and 1100 of a Sankey diagram generated to visualize multiple database data flows between database tables functioning as data sources and database users serving as data clients. In some embodiments, clicking on a tag “T” may not place it within the appropriate tag-based filter field (e.g., 704a-c) but, rather, may cause the tag to be highlighted within a viewport. As shown in FIG. 10, a viewport may be a small window presented adjacent to a Sankey diagram (e.g., showing data flow) and may list relevant portions of a tag hierarchy. According to some embodiments, a relevant tag may include tags that themselves or via one or more descendants tag relate to at least one entity of a given type shown in the Sankey diagram. For example, since three entity types are shown/visible in FIG. 10, there are three viewports, each showing the respective top tag for the column (and associated entity type) within the context of the portion of the tag hierarchy, as applicable to entities of that type.

In FIGS. 10 and 11, two viewports for the same Sankey are shown. In FIG. 10, the screenshot 1000 depicts the “Users” viewport as being shown, where “By Department” is highlighted. Correspondingly, the “Users” column of the Sankey diagram shows the children tags of “By Department.” In accordance with some embodiments, the same viewport only shows “By Department” and “By Manager” as direct children of the “Tableau” tag, even though the latter has additional children. This may be because the other children are used to tag tables and/or queries but not users. As a result the other children are shown to be omitted from the “Users” viewport.

In FIG. 11, the screenshot 1100 depicts the “Tables” viewport, where “By Database Type” is highlighted. Correspondingly, the “Tables” column of the Sankey diagram shows the children tags of “By Database Type.” Again, in accordance with some embodiments, the same viewport shows only table-related children of the “Tableau” tag (e.g., “By Corporate Server”, “By Database Type”, “By Dev Server”) while certain children shown in the “Users” viewport are not shown in the “Tables” viewport (because they are used to organize users but not tables).

According to some embodiments, tags (directly or via descendants) may be used to tag different entity types. For instance, the “Tableau” tag may have some descendant tags used to tag users, and others with tag tables and, thus, the “Tableau” tag appears in both the “Users” and “Tables” viewports.

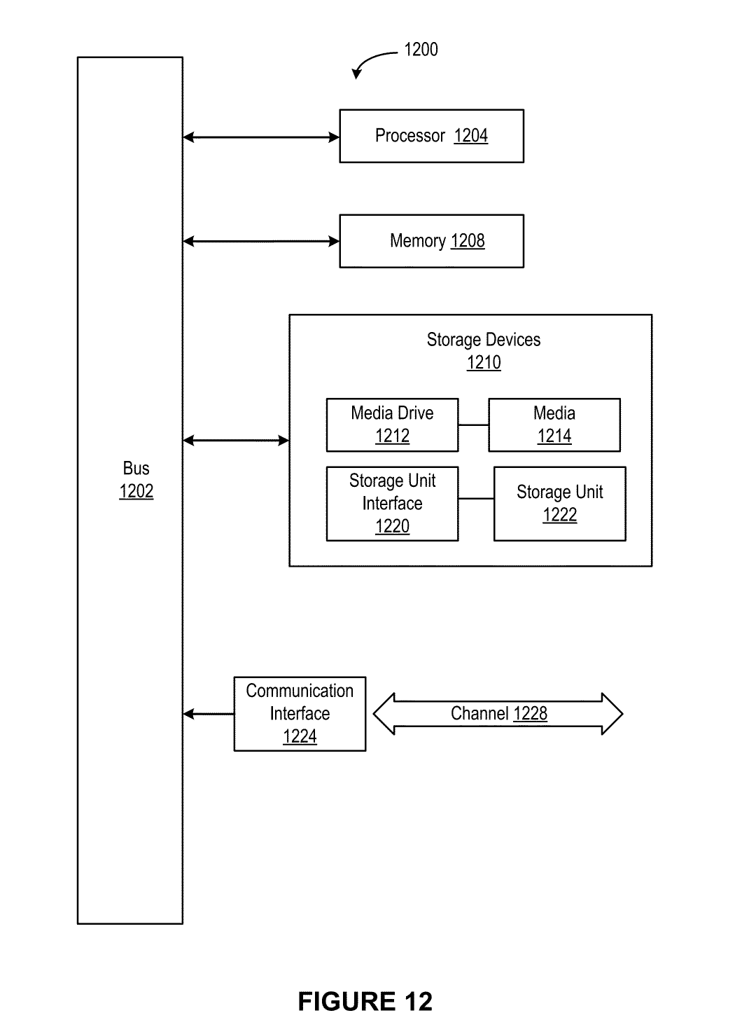

FIGS. 10 and 11 also present how a user has selected three tags for “Tables,” one for “Query,” and two for “Users.” As one per entity type is reflected in the viewport, two tags are shown in the tag field for “Tables,” none for “Query,” and one for “Users.” The multiple tags for each entity may be combined together using Boolean expressions. For example, in the screenshots 1000 and 1110, the example Boolean expression may be “By Department” AND NOT “development” for “Users,” and the example Boolean may be “By Database Type” AND (“dbclass-vertica” OR “dbclass-excel”) for “Tables.” By such Boolean expression, the tag controlling the top node may be first (and reflected in the viewport), and the rest of each expression may reflect the tags shown within the tag fields. The creation of Boolean expressions may be possible via a graphical user interface, command-line, or some combination thereof. For example, a user may use a dropdown menu to select and create an OR filter, or may hover over an existing filter and select “Exclude” in order to turn it into a Boolean NOT. In some embodiments, individual entities may appear in these the Boolean expressions in lieu of tags (e.g., to exclude a specific entity from the visible flows).

Where components or modules of the invention are implemented in whole or in part using software, in one embodiment, these software elements can be implemented to operate with a computing or processing module capable of carrying out the functionality described with respect thereto. One such example computing module is shown in FIG. 12. Various embodiments are described in terms of this example-computing module 1200. After reading this description, it will become apparent to a person skilled in the relevant art how to implement the invention using other computing modules or architectures.

Referring now to FIG. 12, computing module 1200 may represent, for example, computing or processing capabilities found within desktop, laptop and notebook computers; hand-held computing devices (PDA's, smart phones, cell phones, palmtops, tablets, etc.); mainframes, supercomputers, workstations or servers; or any other type of special-purpose or general-purpose computing devices as may be desirable or appropriate for a given application or environment. Computing module 1200 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

In some embodiments, some or all the elements of FIG. 12 may be emulated via “virtualization software,” such as VMWare®, and others. Accordingly, various embodiments may utilize virtualization software that provides an execution environment using emulated hardware, such as a “virtual machine”. The virtualized software may be implemented, and provided, as cloud-based services, such as Amazon Web Services Elastic Compute Cloud.

Computing module 1200 might include, for example, one or more processors, controllers, control modules, or other processing devices, such as a processor 1204. Processor 1204 might be implemented using a general-purpose or special-purpose processing engine such as, for example, a microprocessor, controller, or other control logic. In the illustrated example, processor 1204 is connected to a bus 1202, although any communication medium can be used to facilitate interaction with other components of computing module 1200 or to communicate externally.

Computing module 1200 might also include one or more memory modules, simply referred to herein as main memory 1208. For example, preferably random access memory (RAM) or other dynamic memory, might be used for storing information and instructions to be executed by processor 1204. Main memory 1208 might also be used for storing temporary variables or other intermediate information during execution of instructions to be executed by processor 1204. Computing module 1200 might likewise include a read only memory (“ROM”) or other static storage device coupled to bus 1202 for storing static information and instructions for processor 1204.

The computing module 1200 might also include one or more various forms of information storage mechanism 1210, which might include, for example, a media drive 1212 and a storage unit interface 1220. The media drive 1212 might include a drive or other mechanism to support fixed or removable storage media 1214. For example, a hard disk drive, a floppy disk drive, a magnetic tape drive, an optical disk drive, a CD or DVD drive (R or RW), or other removable or fixed media drive might be provided. Accordingly, storage media 1214 might include, for example, a hard disk, a floppy disk, magnetic tape, cartridge, optical disk, a CD or DVD, or other fixed or removable medium that is read by, written to or accessed by media drive 1212. As these examples illustrate, the storage media 1214 can include a computer usable storage medium having stored therein computer software or data.

In alternative embodiments, information storage mechanism 1210 might include other similar instrumentalities for allowing computer programs or other instructions or data to be loaded into computing module 1200. Such instrumentalities might include, for example, a fixed or removable storage unit 1222 and an interface 1220. Examples of such storage units 1222 and interfaces 1220 can include a program cartridge and cartridge interface, a removable memory (for example, a flash memory or other removable memory module) and memory slot, a PCMCIA slot and card, and other fixed or removable storage units 1222 and interfaces 1220 that allow software and data to be transferred from the storage unit 1222 to computing module 1200.

Computing module 1200 might also include a communications interface 1224. Communications interface 1224 might be used to allow software and data to be transferred between computing module 1200 and external devices. Examples of communications interface 1224 might include a modem or softmodem, a network interface (such as an Ethernet, network interface card, WiMedia, IEEE 802.XX or other interface), a communications port (such as for example, a USB port, IR port, RS232 port, Bluetooth® interface, or other port), or other communications interface. Software and data transferred via communications interface 1224 might typically be carried on signals, which can be electronic, electromagnetic (which includes optical) or other signals capable of being exchanged by a given communications interface 1224. These signals might be provided to communications interface 1224 via a channel 1228. This channel 1228 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 1208, storage unit 1220, media 1214, and channel 1228. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 1200 to perform features or functions of the disclosed invention as discussed herein.

While various embodiments of the disclosed invention have been described above, it should be understood that they have been presented by way of example only, and not of limitation. Likewise, the various diagrams may depict an example architectural or other configuration for the disclosed invention, which is done to aid in understanding the features and functionality that can be included in the disclosed invention. The disclosed invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the invention disclosed herein. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed invention, whether or not such embodiments are described and whether or not such features are presented as being a part of a described embodiment. Thus, the breadth and scope of the invention disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

Embodiments of the invention are further and variously discussed in Appendix A of this application, which is hereby and herein incorporated by reference in its entirety.

What is claimed:

1. A computer implemented method comprising:
capturing, by a computer system, a first data flow between a data source and a data client;
determining, by the computer system, one or more elements relating to the first data flow;
tagging, by the computer system, at least one element of the first data flow with a first tag;
generating, by the computer system, a visual representation of the first data flow based on the elements relating to the data; and
adjusting, by the computer system, the visual representation of the first data flow according to the first tag in response to selection of the first tag.

2. The computer implemented method of claim 1, wherein the first tag is selected by a user.

3. The computer implemented method of claim 1, further comprising tagging another element of the first data flow with a second tag, the adjusting the visual representation comprising adjusting the visual representation of the first data flow according to the first tag and the second tag in response to selection of the first tag and selection of the second tag.

4. The computer implemented method of claim 1, further comprising annotating at least one element of the first data flow with an annotation, the visual representation including the annotation.

5. The computer implemented method of claim 1, further comprising:
analyzing the first data flow; and
optimizing a process for a second data flow based on the analyzing of the first data flow, the second data flow occurring subsequent to the first data flow.

6. The computer implemented method of claim 5, further comprising:
capturing the second data flow; and
analyzing the second data flow using at least the optimized process.

7. The computer implemented method of claim 1, further comprising:
capturing a second data flow; and
determining a first semantic identity for the first data flow;
determining a second semantic identity for the second data flow; and
determining whether the first semantic identity and the second semantic identity are identical.

8. The computer implemented method of claim 7, further comprising analyzing the first data flow based on the determining whether the first semantic identity and the semantic identity are identical.

9. The computer implemented method of claim 8, further comprising analyzing the second data flow based on the determining whether the first semantic identity and the second semantic identity are identical.

10. The computer implemented method of claim 7, wherein the first data flow relates to a first database query to a data source, the second data flow relates to a second database query to the data source, the first semantic identity is a first query alias, and the second semantic identity is a second query alias.

11. The computer implemented method of claim 1, wherein at least one of the capturing the first data flow, the tagging the at least one element of the first data flow, and the selection of the first tag is performed based on a user-defined script.

12. The computer implemented method of claim 11, further comprising performing the user-defined script.

13. The computer implemented method of claim 11, further comprising receiving the user-defined script from a user.

14. The computer implemented method of claim 11, wherein the user-defined script is performed based on satisfaction of a condition.

15. The computer implemented method of claim 14, wherein the condition comprises an occurrence of at least one of an event, a date, and a time.

16. The computer implemented method of claim 1, further comprising organizing the first tag in a tag hierarchy.

17. The computer implemented method of claim 16, wherein the tag hierarchy comprises an acyclic graph of tags.

18. The computer implemented method of claim 1, further comprising performing a search based on the first tag.

19. The computer implemented method of claim 1, further comprising providing two or more users collaborative access to the visual representation and the first tag.

20. A system comprising:
at least one processor; and
a memory storing instructions configured to instruct the at least one processor to perform:
capturing a first data flow between a data source and a data client;
determining one or more elements relating to the first data flow;
tagging at least one element of the first data flow with a first tag;
generating a visual representation of the first data flow based on the elements relating to the data; and
adjusting the visual representation of the first data flow according to the first tag in response to selection of the first tag.

21. A non-transitory computer storage medium storing computer-executable instructions that, when executed, cause a computer system to perform a computer-implemented method comprising:
capturing a first data flow between a data source and a data client;
determining one or more elements relating to the first data flow;
tagging at least one element of the first data flow with a first tag;
generating a visual representation of the first data flow based on the elements relating to the data; and
adjusting the visual representation of the first data flow according to the first tag in response to selection of the first tag.
